(19) United States
(12) Patent Application Publication
(10) Pub. No.: US 2026/0238325 A1
(43) Pub. Date: Aug. 13, 2026

(54) COMMUNICATION APPARATUS AND COMMUNICATION METHOD FOR MULTI-LAYER TRANSMISSION

(71) Applicant: Panasonic Intellectual Property Corporation of America, Torrance, CA (US)

(72) Inventors: Yanyi DING, Singapore (SG); Hiroyuki MOTOZUKA, Kanagawa (JP); Yoshio URABE, Nara (JP)

(73) Assignee: Panasonic Intellectual Property Corporation of America, Torrance, CA (US)

(21) Appl. No.: 19/155,646

(22) PCT Filed: Dec. 22, 2023
(86) PCT No.: PCT/SG2023/050855

§ 371 Date: Aug. 12, 2025

(30) Foreign Application Priority Data
Feb. 17, 2023 (SG) 10202300415U

(51) Int. Cl. H04B 7/06

(52) U.S. Cl. CPC H04B 7/0697

(57) ABSTRACT

The present disclosure provides a communication apparatus and a communication method for multi-layer transmission, the communication apparatus comprising: a module, which, in operations, is configured to generate a signal comprising two or more transmission layers, each of the two or more transmission layers carrying a data stream, wherein the data streams carried in the two or more transmission layers are configured with different sets of transmit parameters but directed to a single second communication apparatus; and a transmitter, which, in operation, transmits the signal to the single second communication apparatus.

### TECHNICAL FIELD

The present disclosure relates to communication apparatuses and methods for multi-layer transmission, and more particularly, multi-layer transmission under different transmit parameters to a single communication apparatus.

### BACKGROUND

In the standardization of next-generation WLAN, a new radio access technology necessarily having backward compatibility with Institute of Electrical and Electronics Engineers (IEEE) 802.11a/b/g/n/ac/ax/be technologies has been discussed in the Ultra High Reliability Study Group (UHR SG).

Multi-layer transmission is an efficient method to improve throughput as well as reliability at physical (PHY) layer. IEEE 802.11 ax/be does not define multi-layer transmission mode. IEEE 802.11n defines unequal modulation (UEQM), which applies different modulation mapping on symbols for different spatial streams. However, UEQM only supports single data stream transmission to a single user.

Broad ideas about multi-layer transmission were discussed in UHR, however, there has been no discussion on the detailed procedure media access control (MAC) layer and PHY layer to implement multi-layer transmission. For example, for MAC layer, there is no clear method to inform PHY layer about how to embed the MAC data to a multi-layer transmission in PHY layer; whereas for PHY layer, there is no signaling in current physical layer protocol data unit (PPDU) to inform a receiver station (STA) about the multi-layer transmission.

There is thus a need for communication apparatuses and methods for multi-layer transmission to address the issues, more particularly, to provide clear method for MAC and PHY layer to implement multi-layer transmission.

Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and communication methods for subcarriers modulation across multiple spatial streams in context of WLAN.

In an embodiment, the present disclosure provides a first communication apparatus comprising: a module, which, in operations, is configured to generate a signal comprising two or more transmission layers, each of the two or more transmission layers carrying a data stream, wherein the data streams carried in the two or more transmission layers are configured with different sets of transmit parameters but directed to a single second communication apparatus; and a transmitter, which, in operation, transmits the signal to the single second communication apparatus.

In another embodiment, the present disclosure provides a second communication apparatus comprising: a receiver, which, in operation, receives a signal from a first communication apparatus, the signal comprising two or more transmission layers, each of the two or more transmission layers carrying a data stream, wherein the data streams carried in the two or more transmission layers are configured with different sets of transmit parameters but directed to the second communication apparatus; and a module, which, in operations, is configured to process and decode the signal.

In yet another embodiment, the present disclosure provides a communication method implemented by a first communication apparatus comprising: generating a signal comprising two or more transmission layers, each of the two or more transmission layers carrying a data stream, wherein the data streams carried in the two or more transmission layers are configured with different sets of transmit parameters but directed to a single second communication apparatus; and transmitting the signal to the single second communication apparatus.

In still yet another embodiment, the present disclosure provides a communication method implemented by a second communication apparatus comprising: receiving a signal comprising two or more transmission layers from a first communication apparatus, each of the two or more transmission layers carrying a data stream, wherein the data streams carried in the two or more transmission layers are configured with different sets of transmit parameters but directed to the second communication apparatus; and processing and decoding the signal.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

Embodiments of the disclosure will be better understood and readily apparent to one of ordinary skilled in the art from the following written description, by way of example only, and in conjunction with the drawings, in which:

FIG. 1 depicts a schematic diagram illustrating a single-user (SU) communication between an access point (AP) and a station (STA) in a multiple-input multiple-output (MIMO) wireless network.

FIG. 2 depicts a schematic diagram illustrating downlink multi-user (MU) communication between an AP and multiple STAs in a MIMO wireless network.

FIG. 3 depicts a schematic diagram illustrating a trigger-based (TB) uplink MU communication between an AP and multiple STAs in a MIMO wireless network.

FIG. 4 shows a diagram illustrating an example unequal modulation (UEQM) transmission procedure to a STA.

FIG. 5 shows a diagram illustrating an IEEE 802.11be transmission procedure to multiple STAs.

FIG. 6 shows a schematic view of a communication apparatus according to the present disclosure.

FIG. 7 shows a flowchart illustrating a communication method implemented by a first communication apparatus.

FIG. 8 shows a flowchart illustrating a communication method implemented by a second communication apparatus.

FIG. 9 shows a diagram illustrating an example multi-layer transmission to a STA according to various embodiments of the present disclosure.

FIG. 10 shows an example PPDU for multi-layer transmission according to various embodiment of the present disclosure.

FIG. 11 shows an example transmitter processing used to process a data field according to various embodiments of the present disclosure.

FIG. 12 shows example data streams in a MAC layer according to a first embodiment of the present disclosure.

FIG. 13 shows example data streams in a MAC layer according to a second embodiment of the present disclosure.

FIG. 14 shows a diagram illustrating an example transmission procedure according to a third embodiment of the present disclosure.

FIG. 15 shows an example transmitter processing used to process a data field according to the third embodiment of the present disclosure.

FIG. 16 shows an example UHR PPDU format for multi-layer transmission according to the third embodiment of the present disclosure.

FIG. 17 shows an example Ultra High Reliability SIGNAL (UHR-SIG) field of a UHR PPDU according to the third embodiment of the present disclosure.

FIG. 18 shows a diagram illustrating an exemplary mapping of a RU Allocation subfield of a Common field and the position of User fields in a UHR PPDU to user's assignment according to the third embodiment of the present disclosure.

FIG. 19 shows another example UHR-SIG field of a UHR PPDU according to the third embodiment of the present disclosure.

FIG. 20A shows a diagram illustrating an exemplary mapping of a RU Allocation subfield of a Common field and the position of ML User field in a UHR PPDU to user's assignment according to the third embodiment of the present disclosure.

FIG. 20B shows a diagram illustrating an exemplary mapping of a Number of Non-OFDMA User subfield of a Common field and the position of ML User field in a UHR PPDU to user's assignment according to the third embodiment of the present disclosure.

FIG. 21 shows a diagram illustrating an example transmission procedure according to a fourth embodiment of the present disclosure.

FIG. 22 shows an example transmitter processing used to process a data field according to various embodiments of the present disclosure.

FIG. 23 shows an example UHR PPDU format for multi-layer transmission according to the fourth embodiment of the present disclosure.

FIG. 24 shows an example UHR-SIG field of a UHR PPDU according to the fourth embodiment of the present disclosure.

FIG. 25 shows a diagram illustrating an exemplary mapping of a RU Allocation subfield of a Common field and the position of User fields in a UHR PPDU to user's assignment according to the third embodiment of the present disclosure.

FIG. 26 shows another example UHR-SIG field of a UHR PPDU according to the fourth embodiment of the present disclosure.

FIG. 27 shows a diagram illustrating an example transmission procedure according to a fifth embodiment of the present disclosure.

FIG. 28 shows an example transmitter processing used to process a data field according to the fifth embodiment of the present disclosure.

FIG. 29 shows an example UHR PPDU format for multi-layer transmission according to the fifth embodiment of the present disclosure.

FIG. 30A shows a diagram illustrating a first example pattern of multi-layer time units according to the fifth embodiment of the present disclosure.

FIG. 30B shows a diagram illustrating a second example pattern of multi-layer time units according to the fifth embodiment of the present disclosure.

FIG. 31 shows a diagram illustrating example transmission layers under a mixed mode of RU and SS according to the sixth embodiment of the present disclosure.

Skilled artisans will appreciate that elements in the figures are illustrated for simplicity and clarity and have not necessarily been depicted to scale. For example, the dimensions of some of the elements in the illustrations, block diagrams or flow charts may be exaggerated in respect to other elements to help an accurate understanding of the present embodiments.

### DETAILED DESCRIPTION

Some embodiments of the present disclosure will be described, by way of example only, with reference to the drawings. Like reference numerals and characters in the drawings refer to like elements or equivalents.

In the following paragraphs, certain exemplifying embodiments are explained with reference to an access point (AP) and a station (STA) for subcarriers modulation across multiple spatial streams, especially in a multiple-input multiple-output (MIMO) wireless network.

In the context of IEEE 802.11 (Wi-Fi) technologies, a station, which is interchangeably referred to as a STA, is a communication apparatus that has the capability to use the IEEE 802.11 protocol. Based on the IEEE 802.11-2016 definition, a STA can be any device that contains an IEEE 802.11-conformant media access control (MAC) and physical layer (PHY) interface to the wireless medium (WM).

For example, a STA may be a laptop, a desktop personal computer (PC), a personal digital assistant (PDA), an access point or a Wi-Fi phone in a wireless local area network (WLAN) environment. The STA may be fixed or mobile. In the WLAN environment, the terms “STA”, “wireless client”, “user”, “user device”, and “node” are often used interchangeably.

Likewise, an AP, which may be interchangeably referred to as a wireless access point (WAP) in the context of IEEE 802.11 (Wi-Fi) technologies, is a communication apparatus that allows STAs in a WLAN to connect to a wired network. The AP usually connects to a router (via a wired network) as a standalone device, but it can also be integrated with or employed in the router.

As mentioned above, a STA in a WLAN may work as an AP at a different occasion, and vice versa. This is because communication apparatuses in the context of IEEE 802.11 (Wi-Fi) technologies may include both STA hardware components and AP hardware components. In this manner, the communication apparatuses may switch between a STA mode and an AP mode, based on actual WLAN conditions and/or requirements.

In a MIMO wireless network, “multiple” refers to multiple antennas used simultaneously for transmission and multiple antennas used simultaneously for reception, over a radio channel. In this regard, “multiple-input” refers to multiple transmitter antennas, which input a radio signal into the channel, and “multiple-output” refers to multiple receiver antennas, which receive the radio signal from the channel and into the receiver. For example, in an N×M MIMO network system, N is the number of transmitter antennas, M is the number of receiver antennas, and N may or may not be equal to M.

For the sake of simplicity, the respective numbers of transmitter antennas and receiver antennas are not discussed further in the present disclosure.

In a MIMO wireless network, single-user (SU) communications and multi-user (MU) communications can be deployed for communications between communication apparatuses such as APs and STAs. MIMO wireless network has benefits like spatial multiplexing and spatial diversity, which enable higher data rates and robustness through the use of multiple spatial streams.

In various embodiments below, each of the terms “channel” and “subchannel” may be used interchangeably with any one of “band”, “subband” and “frequency segments”. The term “circuitry” may be used interchangeably with “module”.

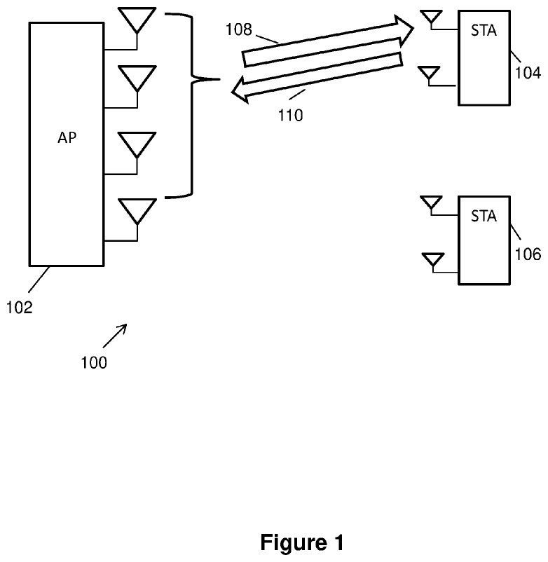

FIG. 1 depicts a schematic diagram illustrating a SU communication 100 between an AP 102 and a STA 104 in a MIMO wireless network. As shown, the MIMO wireless network may include one or more STAs (e.g., STA 104, STA 106, etc.). If the SU communication 100 in a channel is carried out over whole channel bandwidth, it is called full bandwidth SU communication. If the SU communication 100 in a channel is carried out over a part of the channel bandwidth (e.g., one or more 20 MHz subchannels within the channel is punctured), it is called punctured SU communication. In the SU communication 100, the AP 102 transmits multiple space-time streams using multiple antennas (e.g., four antennas as shown in FIG. 1) with all the space-time streams directed to a single communication apparatus, i.e., the STA 104. For the sake of simplicity, the multiple space-time streams directed to the STA 104 are illustrated as a grouped data transmission arrow 108 directed to the STA 104.

The SU communication 100 can be configured for bi-directional transmissions. As shown in FIG. 1, in the SU communication 100, the STA 104 may transmit multiple space-time streams using multiple antennas (e.g., two antennas as shown in FIG. 1) with all the space-time streams directed to the AP 102. For the sake of simplicity, the multiple space-time streams directed to the AP 102 are illustrated as a grouped data transmission arrow 110 directed to the AP 102.

As such, the SU communication 100 depicted in FIG. 1 enables both uplink and downlink SU transmissions in a MIMO wireless network.

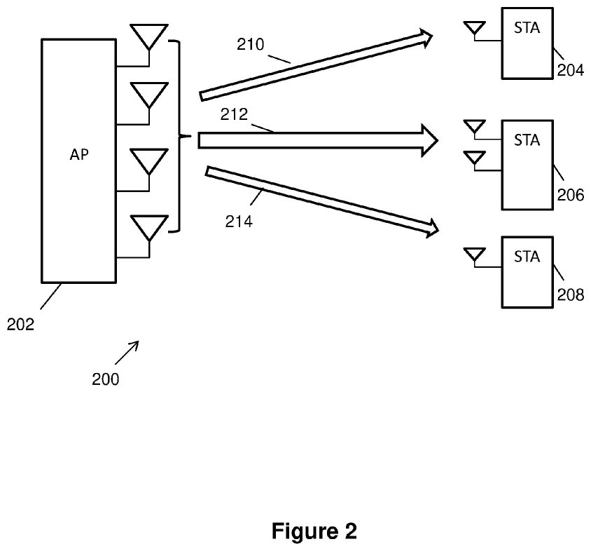

FIG. 2 depicts a schematic diagram illustrating a downlink MU (multiple-user) communication 200 between an AP 202 and multiple STAs 204, 206, 208 in a MIMO wireless network. The MIMO wireless network may include one or more STAs (e.g., STA 204, STA 206, STA 208, etc.). The MU communication 200 may be an OFDMA (orthogonal frequency division multiple access) communications or a MU-MIMO communication. For an OFDMA communication in a channel, the AP 202 transmits multiple streams simultaneously to the STAs 204, 206, 208 in the network at different resource units (RUs) within the channel bandwidth. For a MU-MIMO communication in a channel, the AP 202 transmits multiple streams simultaneously to the STAs 204, 206, 208 at same RU(s) within the channel bandwidth using multiple antennas via spatial mapping or precoding techniques. If the RU(s) for the OFDMA or MU-MIMO communication occupies whole channel bandwidth, the OFDMA or MU-MIMO communications is called full bandwidth OFDMA or MU-MIMO communications. If the RU(s) for the OFDMA or MU-MIMO communication occupies a part of channel bandwidth (e.g., one or more 20 MHz subchannel within the channel is punctured), the OFDMA or MU-MIMO communication is called punctured OFDMA or MU-MIMO communications. For example, two space-time streams may be directed to the STA 206, another space-time stream may be directed to the STA 204, and yet another space-time stream may be directed to the STA 208. For the sake of simplicity, the two space-time streams directed to the STA 206 are illustrated as a grouped data transmission arrow 212, the space-time stream directed to the STA 204 is illustrated as a data transmission arrow 210, and the space-time stream directed to the STA 208 is illustrated as a data transmission arrow 214.

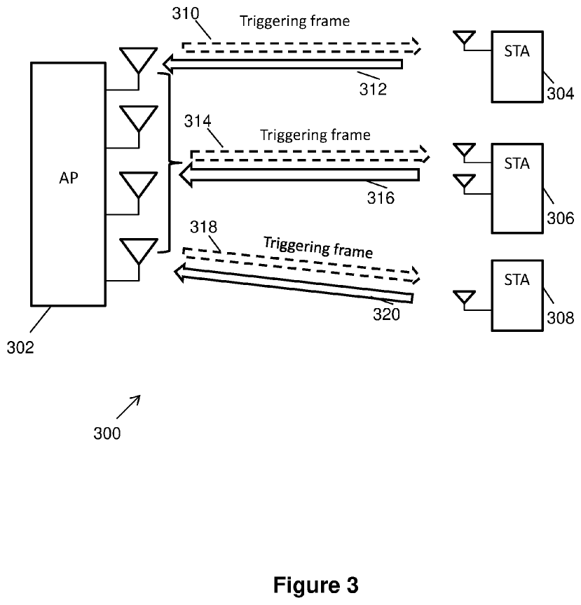

To enable uplink MU transmissions, trigger-based communication is provided to the MIMO wireless network. In this regard, FIG. 3 depicts a schematic diagram illustrating a trigger-based (TB) uplink MU communication 300 between an AP 302 and multiple STAs 304, 306, 308 in a MIMO wireless network.

Since there are multiple STAs 304, 306, 308 respectively participating in the trigger-based uplink MU communication, the AP 302 needs to coordinate simultaneous transmissions of multiple STAs 304, 306, 308.

To do so, as shown in FIG. 3, the AP 302 transmits triggering frames 310, 314, 318 simultaneously to STAs 304, 306, 308 respectively to indicate user-specific resource allocation information (e.g., the number of space-time streams, a starting STS number and the allocated RUs) that each STA can use. In response to the triggering frames, STAs 304, 306, 308 may then transmit their respective space-time streams simultaneously to the AP 302 according to the user-specific resource allocation information indicated in the triggering frames 310, 314, 318. For example, two space-time streams may be directed to the AP 302 from STA 306, another space-time stream may be directed to the AP 302 from STA 304, and yet another space-time stream may be directed to the AP 302 from STA 308. For the sake of simplicity, the two space-time streams directed to the AP 302 from STA 306 are illustrated as a grouped data transmission arrow 316, the space-time stream directed to the AP 302 from STA 304 is illustrated as a data transmission arrow 312, and the space-time stream directed to the AP 302 from STA 308 is illustrated as a data transmission arrow 320.

Due to packet/PPDU (physical layer protocol data unit) based transmission in the Enhanced Distributed Channel Access (EDCA) mechanism and distributed MAC (medium access control) scheme in IEEE 802.11 WLAN, frequency and spatial resource scheduling is performed on a packet basis. In other words, resource allocation information is on a PPDU basis in the EDCA mechanism.

WLAN supports non-trigger-based communications as illustrated in FIGS. 1 and 2 and trigger-based communications as illustrated in FIG. 3. In non-trigger-based communications, a communication apparatus transmits a PPDU to one other communication apparatus or more than one other communication apparatus in an unsolicited manner. In trigger-based communications, a communication apparatus transmits a PPDU to one other communication apparatus or more than one other communication apparatus only after a soliciting triggering frame is received.

As mentioned earlier, as different layers of transmission are protected by different parameters (e.g., modulation rate, coding rate) to provide different robustness or error rate, multi-layer transmission can improve throughput as well as reliability at PHY layer. For example, in IEEE 802.11n, unequal modulation (UEQM) being used on different spatial streams (SSs) to a single STA in a PPDU is allowed. In each PPDU, only 1 physical layer service data unit (PSDU) is carried and transmitted to one STA and only single-user is supported. In IEEE 802.11ax/be, different modulation and coding schemes (MCS) being used on different resource units/multiple resource units (RU/MRU) and different SSs to multiple different STAs in a same PPDU is allowed. In each PPDU, N PSDUs are carried and transmitted to N STAs (where N is an integer, N≥1). One PSDU is transmitted to one STA, and the MCS to a single STA is same across multiple RU/MRUs or SSs. It is noted that PSDU is a view of the MAC data from the PHY layer.

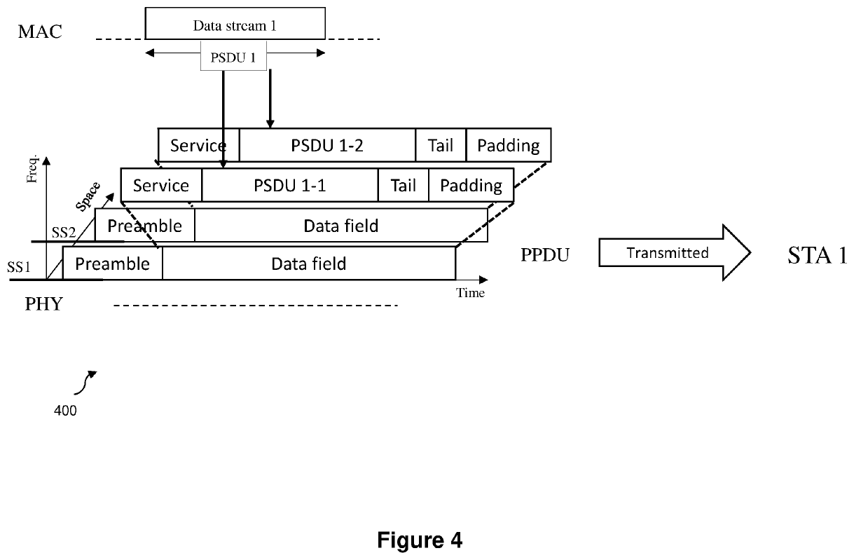

FIG. 4 shows a diagram 400 illustrating an example UEQM transmission procedure to a STA. In this example, modulation rates can be different across different SSs (e.g., SS1 and SS2) carrying a single PSDU (e.g., PSDU 1) targeted at a single STA (e.g., STA1). For a single receiver STA (e.g., STA1), the modulation rate can be different. A data stream in MAC layer is transferred to a single PSDU (e.g., PSDU 1-1 and PSDU 1-2 both belong to PSDU 1) carried by multiple spatial streams (e.g., SS1 and SS2) in PHY layer (for the sake of simplicity, only two SSs are shown, i.e., PSDU 1-1 in SS1 and PSDU 1-2 in SS2) and during the phase when MAC layer transfer data to PHY layer, only one PSDU targeted at a single STA (STA1) is transferred. During the phase when PHY layer transmits the data in a PPDU, the different modulation rate for each SS is indicated by MCS information of the PPDU preamble. The PPDU is then transmitted to STA1.

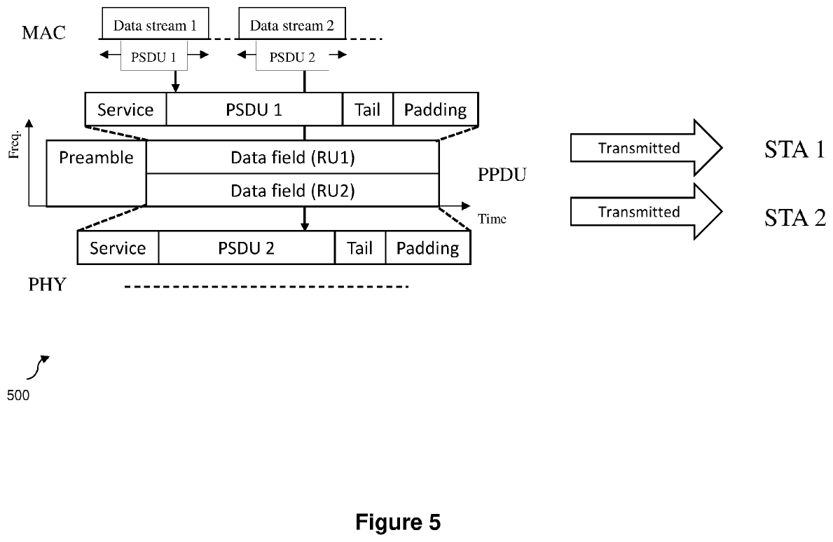

FIG. 5 shows a diagram 500 illustrating an OFDMA transmission procedure to multiple STAs. In this example, modulation rates can be different across different RUs or SSs. In each RU/SS of the different RUs/SSs, a single PSDU is carried and sent to single STA. For a single receiver STA (e.g., STA1 or STA2), the MCS should be identical across all resources. The different data streams (e.g., data stream 1 and data stream 2) in MAC layer targeted at different STAs (e.g., STA1 and STA2) are transferred to different RUs (e.g., RU1 and RU2) in PHY layer. For the sake of simplicity, two PSDUs (PSDU1, PSDU2) targeted at different STAs (STA1, STA2) are illustrated. During the phase when MAC layer transfers data to PHY layer, only one PSDU targeted at respective STA is transferred, more particularly, PSDU1 targeted at STA1 is transferred to RU1 and PSDU2 targeted at STA2 is transferred to RU2 of the data fields in a PPDU. During the phase when PHY layer transmits the data in the PPDU, the MCSs for each RU/SS may be indicated by RU allocation field and user field of the PPDU preamble and the MCS for each RU/SS may be different.

Presently, while broad idea about multi-transmission has been discussed in UHR SG, there is no clear method to inform PHY layer about how to embed the MAC data to a multi-layer transmission in PHY layer; while there is no signalling in current PPDU for PHY layer to inform a receiver STA about the multi-layer transmission.

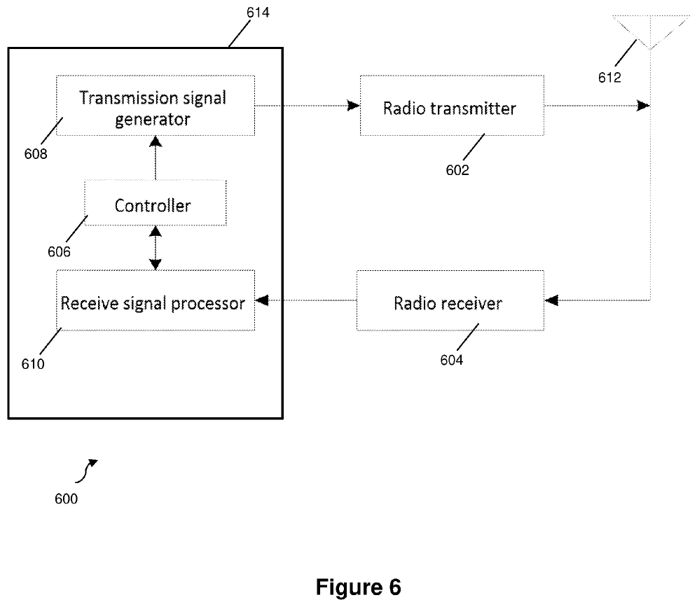

FIG. 6 shows a schematic view of a communication apparatus 600 according to the present disclosure. The communication apparatus 600 may be implemented as an AP or a STA.

As shown in FIG. 6, the communication apparatus 600 may include circuitry 614, at least one radio transmitter 602, at least one radio receiver 604, and at least one antenna 612 (for the sake of simplicity, only one antenna is depicted in FIG. 6 for illustration purposes). The circuitry 614 may include at least one controller 606 for use in software and/or hardware aided execution of tasks that the at least one controller 606 is designed to perform, including but not limited to control of communications with one or more other communication apparatuses in a MIMO wireless network. The circuitry 614 may further include at least one transmission signal generator 608 and at least one receive signal processor 610. The at least one controller 606 may control the at least one transmission signal generator 608 for generating PPDUs to be sent through the at least one radio transmitter 602 to one or more other communication apparatuses. Here, the PPDU, for example, may be PPDUs used for downlink transmissions if the communication apparatus 600 is an AP. Alternatively, the PPDU may be PPDUs used for trigger-based uplink transmissions if the communication apparatus 600 is a STA. The at least one controller 606 may control the at least one receive signal processor 610 for processing MAC frames and PPDUs received through the at least one radio receiver 604 from the one or more other communication apparatuses under the control of the at least one controller 606. Here the PPDU, for example, may be PPDUs used for trigger-based uplink transmissions if the communication apparatus 600 is an AP. Alternatively, the PPDU may be PPDUs used for downlink transmissions if the communication apparatus 600 is a STA. The at least one transmission signal generator 608 and the at least one receive signal processor 610 may be stand-alone modules of the communication apparatus 600 that communicate with the at least one controller 606 for the above-mentioned functions, as shown in FIG. 6. Alternatively, the at least one transmission signal generator 608 and the at least one receive signal processor 610 may be included in the at least one controller 606. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 602, at least one radio receiver 604, and at least one antenna 612 may be controlled by the at least one controller 606.

The communication apparatus 600, when in operation, may provide functions required for multi-layer transmission. For example, the communication apparatus 600 may be an AP, and the circuitry 614 (for example the at least one transmission signal generator 608 of the circuitry 614, respectively) may be configured to generate a signal comprising two or more transmission layers, each of the two or more transmission layers carrying a data stream, wherein the data streams carried in the two or more transmission layers are configured with different sets of transmit parameters but directed to a single second communication apparatus. The at least one radio transmitter 602 may transmit the signal to the single second communication apparatus.

In one embodiment, the circuitry 614 (for example the at least one transmission signal generator 608 of the circuitry 614, respectively) further comprises a first sub-module (e.g., PHY layer) which is configured to separately process and embed each of the two or more data streams into a part of the signal to generate the signal.

In another embodiment, the circuitry 614 (for example the at least one transmission signal generator 608 of the circuitry 614, respectively) further comprises a second sub-module (e.g., MAC layer) which is configured to report a priority level of each of the data streams to be carried in the two or more transmission layers together with the data streams to the first sub-module, wherein the first sub-module is configured to generate the signal using the indicated sets of transmit parameters.

For example, the communication apparatus 600 may be a receiver STA, and the at least one radio receiver 604 may receive a signal from another communication apparatus. The signal comprises two or more transmission layers, each of the two or more transmission layers carrying a data stream, wherein the data streams carried in the two or more transmission layers are configured with different sets of transmit parameters but directed to the second communication apparatus. The circuitry 614 (for example the at least one receive signal processor 610 of the circuitry 614, respectively) may be configured to process and decode the signal.

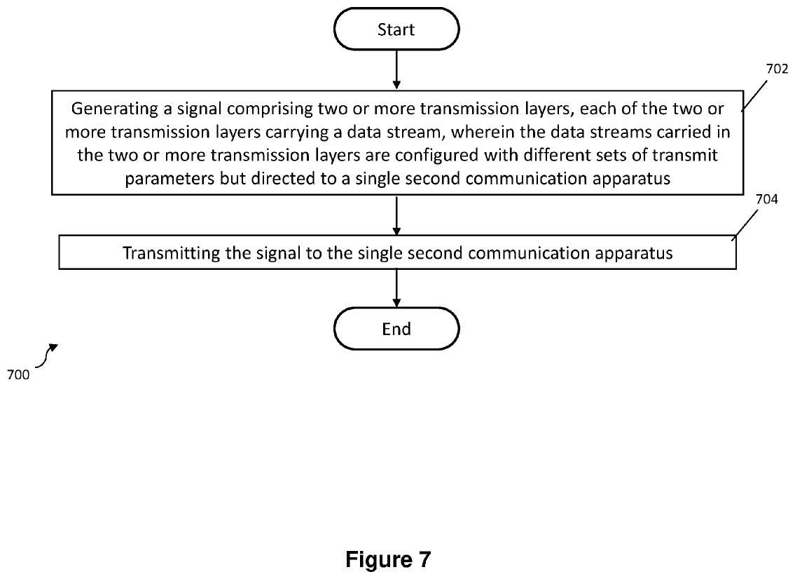

FIG. 7 shows a flowchart 700 illustrating a communication method implemented by a first communication apparatus. The first communication apparatus, for example, may be an AP according to various embodiments of the present disclosure. In step 702, a signal comprising two or more transmission layers is generated, each of the two or more transmission layers carrying a data stream. The data streams carried in the two or more transmission layers may be configured with different sets of transmit parameters but directed to a single second communication apparatus. In step 704, a step of transmitting the signal to the single second communication apparatus is carried out.

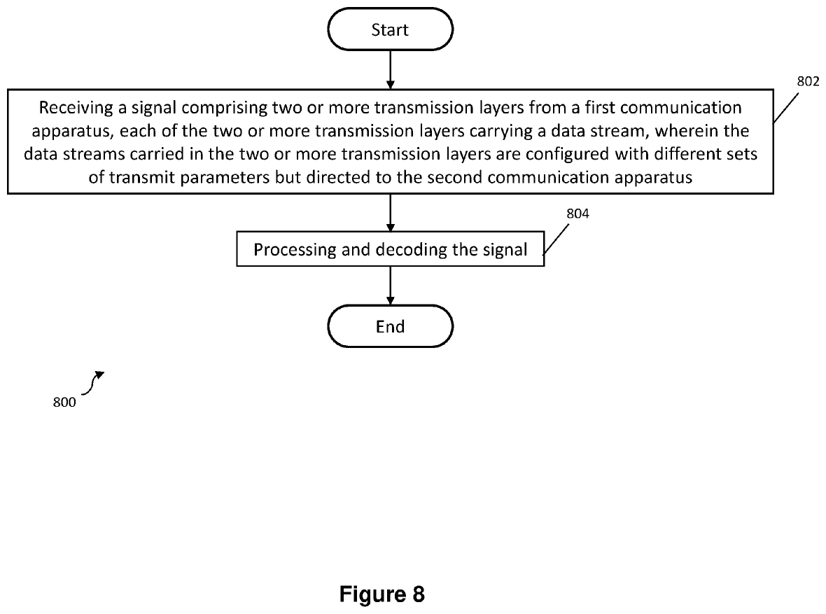

FIG. 8 shows a flowchart 800 illustrating a communication method implemented by a second communication apparatus. The second communication apparatus, for example, may be a receiver STA according to various embodiments of the present disclosure. In step 802, a signal comprising two or more transmission layers is received from a first communication apparatus, each of the two or more transmission layers carrying a data stream. The data streams carried in the two or more transmission layers may be configured with different sets of transmit parameters but directed to the second communication apparatus. In step 804, a step of processing and decoding the signal is carried out.

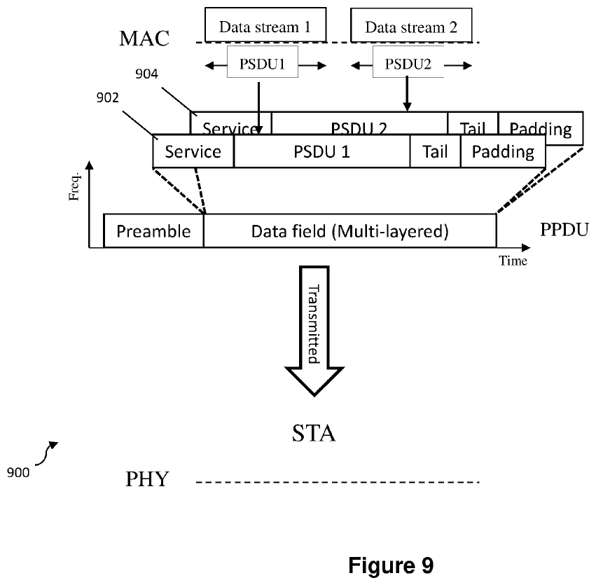

According to the present disclosure, one or more data streams that are carried by different transmission layers are transmitted to a single STA in a multi-layer transmission. Each of the different transmission layers is protected by different transmit parameters in a PPDU. FIG. 9 shows a diagram 900 illustrating an example multi-layer transmission to a STA according to various embodiments of the present disclosure.

In a multi-layer transmission, multiple coded packets are transmitted, each of which is referred to as a transmission layer. In particular, different transmission layers are protected by different parameters (e.g., modulation rate, coding rate), thus different robustness or error rates can be provided to different transmission layers. According to the present disclosure, a multi-layer transmission procedure may include the following two steps:
Step 1: one or more data streams (e.g., data stream 1, data stream 2) are transferred from MAC layer to PHY layer to form different PSDUs (e.g., PSDU 1, PSDU 2 in FIG. 9) carried in different transmission layers 902, 904 in a PPDU. Step 1 may be implemented by any of the following two options:
   Option 1: different data streams may be separated as different PSDUs in PHY layer; and
   o Option 2: different data streams may be seen as a single PSDU in PHY layer.
Step 2: transmission layers 902, 904 carrying the PSDUs protected by different transmit parameters in the PPDU are transmitted to a single STA. Step 2 may be implemented by any of the following four options:
   Option 3: spatial stream;
   Option 4: resource unit (alternatively, frequency channel, subchannel, etc.);
   Option 5: time unit; and
   Option 6: mixed mode, i.e., a combination of spatial stream, resource unit and/or time unit.
      The multi-layer transmission procedure may be used for transmitting one or more data streams to a single apparatus, for example, a single STA.

In the PPDU, the necessary information regarding the configuration of transmission layers and transmit parameters for different transmission layers are indicated.

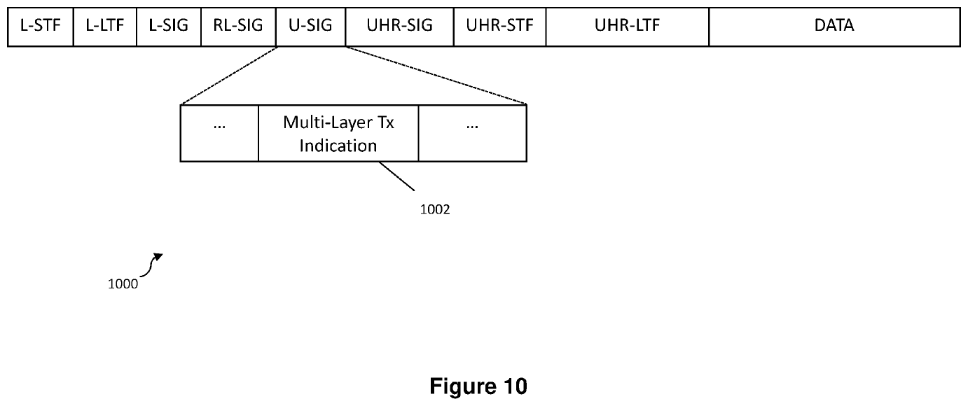

FIG. 10 shows an example PPDU 1000 for multi-layer transmission according to various embodiment of the present disclosure. The PPDU 1000 may include a Legacy Short Training Field (L-STF), a Legacy Long Training Field (L-LTF), a Legacy SIGNAL (L-SIG) field, a Repeated L-SIG (RL-SIG) field, a Universal SIGNAL (U-SIG) field, a Ultra High Reliability SIGNAL (UHR-SIG) field, a UHR Short Training Field (UHR-STF), a UHR Long Training Field (UHR-LTF) and a Data field. In the U-SIG field or a Common field (not shown) of the UHR-SIG field, the transmission layer option applied to the PPDU may be indicated through a Multi-Layer transmission (Tx) Indication subfield 1002. It is noted that, subfields marked with ellipsis are general subfields that are contained in U-SIG field in IEEE802.11be or would be contained in U-SIG field in future IEEE802.11 amendments. An indication (e.g. value, subfield, field or indication bit, capability bit, signal) that indicates whether multi-layer transmission is applied or not and/or which multi-layer transmission option is applied to the PPDU may be included in a preamble part (e.g. L-SIG, RL-SIG, U-SIG, and/or UHR-SIG fields) of the PPDU. For example, Table 1 shows the various transmission layer options corresponding to the values of the Multi-layer Tx Indication subfield in the U-SIG field or the Common field of the UHR-SIG field. Alternatively, a Multi-Layer Tx Indication subfield may be included in a User Specific field (not shown) in the UHR-SIG field of the PPDU. Table 2 shows an alternative indication (e.g., Multi-layer Tx Indication subfield) that indicates explicitly or implicitly whether multi-layer transmission is applied to the PPDU. For explicit indication, for example, a Multi-layer Tx Indication subfield may be included in the Common field or User Specific field (not shown) of the UHR-SIG field. For implicit indication, for example, use of multi-layer transmission may be indicated by assigning multiple resources (e.g. SSs, RUs, time-slots, etc.) to a single receiver STA.

TABLE 1

| Value | Transmission layer |
|---|---|
| 0 | SS |
| 1 | RU |
| 2 | Time unit |
| 3 | RU + SS |
| 4 | RU + time units |
| 5 | Time units + SS |
| 6 | RU + SS + time units |
| 7 | Reserved |

TABLE 2

| Value | Transmission layer |
|---|---|
| 0 | Multi-layer transmission is not applied |
| 1 | Multi-layer transmission is applied |

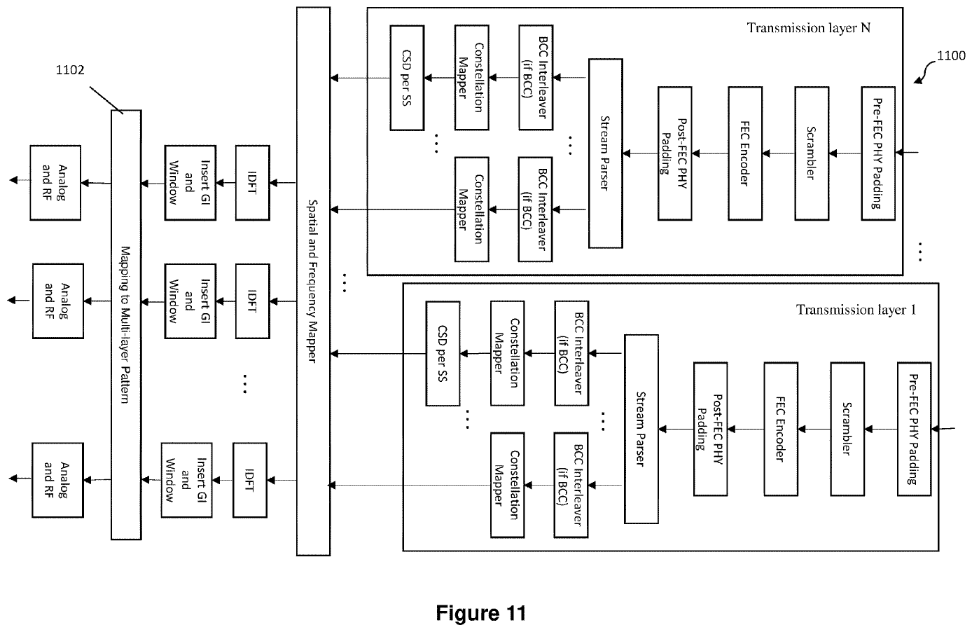

FIG. 11 shows an example transmitter processing 1100 used to process a data field according to various embodiments of the present disclosure. The Transmission layer units 1 to N perform encoding and modulation processing on data streams. For example, Transmission layer units 1 and 2 performs encoding and modulation on data stream 1 and 2, which are shown in FIG. 9, respectively. In one embodiment, the transmitter processing may start at each transmission layer (e.g., transmission layers 1-N) with its respective Pre-Forward Error Correction (FEC) Physical Layer (PHY) Padding unit where redundant information is added to the data bits before the data is output to a Scrambler for scrambling the data bits to reduce long runs of identical bits on the transmission layer. An FEC encoder unit encodes the data bits using forward error correction code (e.g. binary convolutional code (BCC), low density parity code (LDPC), etc) before the encoded data is output to a Post-FEC PHY Padding unit to add padding bits such that the number of bits match the number of bits required for a symbol.

A Stream Parser unit then divides the encoded bits into multiple blocks that are sent through multiple spatial streams correspondingly. The single spatial stream corresponding to a block of the encoded bits is sent to BCC Interleaver unit which interleaves the bits of each spatial stream (changes order of bits) to prevent long sequences of adjacent noisy bits before it is sent to a Constellation Mapper unit. The BCC Interleaver unit may be omitted depending on the employed FEC code type. For example, BCC Interleaver unit is omitted or the Interleave process is skipped when an LDPC is applied to the encoding of the PSDU. The Constellation Mapper unit maps respective blocks of the encoded bits into constellation points or complex numbers (herein referred to as modulation symbols) using a selected modulation scheme and ensure respective OFDM subcarriers are separated by a sufficient distance to maximize frequency diversity gain.

Subsequently, the spatial streams of all transmission layers will be sent to a Spatial and Frequency Mapper unit to map onto one or multiple transmit chains. Each transmit chain is sent to an Inverse Fourier Discrete Fourier Transform (IDFT) unit. Each IDFT unit converts OFDM subcarriers on the transmit chain, which are frequency-domain data, into time-domain data for transmission. The time-domain data of the IDFT unit is then sent to an Insert Guard Interval (GI) And Window unit to insert GI at the start of each OFDM symbol in the transmit chain where each OFDM symbol may also be windowed to minimize adjacent channel interference. The time-domain data in each transmit chain is then sent to a Mapping to Multi-layer Pattern unit 1102 to map different symbols of each transmit chain to different transmission layers (e.g., when PSDUs targeted at a single STA is carried by different time units under Option 5 or 6) before sending it to an Analog and Radio Frequency (RF) unit to prepare the data for transmission through an antenna.

For example, under Option 1, different data streams targeted at a single STA may be separated as different PSDUs protected by different transmit parameters and embed in different transmission layers of the transmission layers 1-N. The PSDUs run through respective pre-FEC PHY padding units, Scrambler units, FEC Encoder units, Post-FEC Padding units, Stream Parser units, BCC Interleaver units, Constellation Mapper units and CSD per SS units relating to the different transmission layers before sending to the Spatial and Frequency Mapper unit. Under Option 2, different data streams targeted at a single STA may be seen as a single PSDU, protected by different transmit parameters and embed in different transmission layers. The PSDU or data stream then run through the pre-FEC PHY padding unit, Scrambler unit, FEC Encoder unit, Post-FEC Padding unit, Stream Parser unit, BCC Interleaver unit, Constellation Mapper unit and CSD per SS unit relating to the transmission layer before sending to the Spatial and Frequency Mapper unit. Under Option 3, each of the transmission layers 1-N is carried by a different spatial stream. Under Option 4, each of the transmission layers 1-N is carried by a different resource unit, frequency channel or subchannel. Under Option 5, each of the transmission layers 1-N is carried by a different time unit. Under Option 6, each of the transmission layers 1-N is carried by a different combination of spatial stream, resource unit and time unit. It is noted that Options 1 and 2 are still applicable under Options 3-6.

The Mapping to Multi-layer Pattern unit 1102 is optionally present if the communication apparatus supports multi-layer transmission Option 5 and/or 6 with time-units basis protection and the PPDU is transmitted using either of the multi-layer transmission Options 5 and 6 with time-units basis protection. Otherwise, for example, under Options 3, 4, and 6 without time-units basis protection the Mapping to Multi-layer Pattern unit 1102 is not implemented in the communication apparatus or the process by the unit is skipped.

In the following paragraphs, a first embodiment of the present disclosure is described.

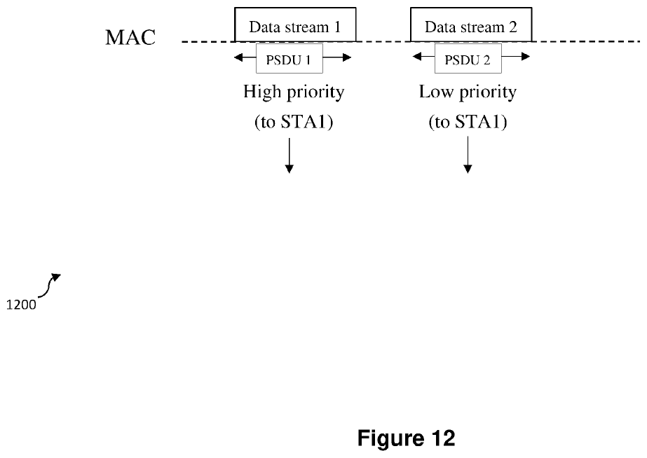

FIG. 12 shows a diagram 1200 illustrating example data streams in a MAC layer according to the first embodiment of the present disclosure. Different data streams (e.g., data stream 1, and data stream 2) targeted at a single STA (e.g., STA1) are sent from MAC layer to PHY layer separately. The data streams can be separated based on different dimension such as priority levels, importance levels, latency requirement levels, data types or other dimensions. In this example, data stream 1 is set with “high” priority while data stream 2 is set with “low” priority. Both data streams 1 and 2 are targeted at a single STA (e.g., STA1). The priority level of each data stream may be determined based on User Priority (UP), Access Category (AC), Traffic Identifier (TID) and/or Traffic Classification (TCLAS) in MAC layer. The MAC layer may determine the priority level based on information indicated via MAC Layer Management Entity SAP (MLME-SAP) or information included in a higher layer packet, such as IP header fields, via MAC SAP. Data streams 1 and 2 are sent from MAC layer to PHY layer separately based on their priority levels. In particular, data stream 1 may be embedded in PSDU 1, and data stream 2 may be embedded in PSDU 2. The PHY interfaces for priority may be defined in a similar way as the MAC interfaces for UP directly by PHY-SAP (Service Access Point) and optionally via Physical Layer Management Entity SAP (PLME-SAP) for additional settings.

Example primitive used to send the data from MAC layer to PHY layer may be as follows:

```
PHY-DATA.request(
  DATA,
  USER_INDEX,
  STA_INDEX,
  P_LEVEL
).
```

PHY_DATA.request is a primitive that defines the transfer of an octet of data from MAC layer to the local PHY layer. The P_LEVEL parameter indicates the priority level of the data stream from which the accompanying data octet is from. It may be identified as DATA_LEVEL parameter in TXVECTOR.

The MAC layer uses the TXVECTOR to supply PHY layer with per-PPDU transmit parameters (RU allocation, SS allocation and MCS, etc.). In the TXVECTOR for the PPDU that will protect the different data streams targeted at a single STA with different transmit parameters, the transmit parameters for each data stream are indicated. The correspondence between different transmit parameters and different data streams can be indicated in the TXVECTOR either explicitly or implicitly.

To explicitly indicate the correspondence between different transmit parameters and different data stream, the different levels of data streams may be indicated in TXVECTOR while transmit parameters are indicated per level of data stream per STA in TXVECTOR. Table 3 shows details and formats of two parameters in TXVECTOR used to explicitly indicate the correspondence between different transmit parameters and different data stream. The UHR_MU format is applicable to both MU and SU transmission.

TABLE 3

| Parameter | Condition | Value |
|---|---|---|
| STA_ID | FORMAT is | Indicates the list of STA-IDs for an UHR |
| | UHR_MU | MU PPDU. |
| | | Note: the same STA_ID is present for |
| | | same number of times as the number of |
| | | levels of corresponding data streams. |
| DATA_{—} | FORMAT is | Indicates the corresponding list of |
| LEVEL | UHR_MU | different priority levels of data streams |
| | | per STA carried by an UHR MU PPDU. |
| | | Note: this parameter may not be present |
| | | in the UHR MU PPDU. |

DATA_LEVEL parameter in TXVECTOR may identify whether the data transmitted on an RU in the UHR MU PPDU is a multi-layer transmission: if yes, the DATA_LEVEL may identify the data stream is transmitted with which set of transmit parameters applied to the RU; and if no, DATA_LEVEL may be set to 0. Such DATA_LEVEL can be same as P_LEVEL of the PHY-DATA.request and be used to indicate a priority level of a data stream targeted at a STA. It is noted that the concrete transmit parameters (e.g., MCS) for each priority level of data stream is implementation dependent.

Table 4 shows an example table listing out parameters in the TXVECTOR used to implicitly indicate the correspondence between different transmit parameters and different data streams targeted at four different STAs (STA_IDs are from 1 to 4) according to the first embodiment of the present disclosure. The two entries of STA_ID 2 indicate that there are two data streams targeted at STA of STA_ID 2 carried in the UHR MU PPDU, and the DATA_LEVEL values 1 and 2 indicates that the two data streams targeted at STA of STA_ID 2 has a priority level of 1 and 2, respectively. The DATA_LEVEL value of 0 indicates that the data transmitted on the RU in the UHR MU PPDU for STAs of STA_IDs 1, 3 and 4 is not a multi-layer transmission.

TABLE 4

| | | | | | |
|---|---|---|---|---|---|
| STA_ID | 1 | 2 | 2 | 3 | 4 |
| DATA_LEVEL | 0 | 1 | 2 | 0 | 0 |

The correspondence between different transmit parameters and different data stream may be implicitly indicated when the different levels of data streams (e.g., DATA_LEVEL parameter) are not indicated in TXVECTOR but the transmit parameters may be indicated per level of data stream per STA in TXVECTOR. Table 5 shows details and formats of a parameter in a first exemplary TXVECTOR used to implicitly indicate the correspondence between different transmit parameters and different data stream according to the first embodiment of the present disclosure.

TABLE 5

| Parameter | Condition | Value |
|---|---|---|
| STA_ID | FORMAT is | Indicates the list of STA-IDs for an UHR |
| | UHR_MU | MU PPDU. |
| | | Note: the same STA_ID is present for |
| | | same number of times as the number of |
| | | levels of corresponding data streams. |

Table 6 shows an example table listing out the parameter in the first exemplary TXVECTOR used to implicitly indicate the correspondence between different transmit parameters and different data streams targeted at four different STAs (STA_IDs are from 1 to 4) according to the first embodiment of the present disclosure. The two entries of STA_ID 2 indicate that there are two data streams targeted at STA of STA_ID 2 carried in the UHR MU PPDU, and for each of the other STAs (STAs of STA_IDs 1, 3 and 4), the single entry indicates that there is only one data stream targeted on the STA carried in the UHR MU PPDU.

TABLE 6

| | | | | | |
|---|---|---|---|---|---|
| STA_ID | 1 | 2 | 2 | 3 | 4 |

For STA with STA_ID 2, there are two sets of transmit parameters are indicated in the TXVECTOR. The set of transmit parameters providing higher reliability is assigned to the data stream with higher priority.

Alternatively, Table 7 shows details and formats of two parameters in a second exemplary TXVECTOR used to implicitly indicate the correspondence between different transmit parameters and different data stream according to the first embodiment of the present disclosure.

TABLE 7

| Parameter | Condition | Value |
|---|---|---|
| STA_ID | FORMAT is UHR_MU | Indicates the list of STA-IDs |
| | | for an UHR MU PPDU. |
| NUM_DS | FORMAT is UHR_MU | Indicates the number of |
| | | data streams per STA |
| | | for an UHR MU PPDU. |

Table 8 shows an example table listing out the parameter in the second exemplary TXVECTOR used to implicitly indicate the correspondence between different transmit parameters and different data streams targeted at four different STAs (STA_IDs are from 1 to 4) according to the first embodiment of the present disclosure.

TABLE 8

| | | | | |
|---|---|---|---|---|
| STA_ID | 1 | 2 | 3 | 4 |
| NUM_DS | 1 | 2 | 1 | 1 |

In Table 8, the number of data streams corresponding to each STA_ID is indicated. In particular, it is indicated that there are two data streams targeted at STA of STA_ID 2 carried in the UHR MU PPDU, and one data stream targeted at each of the other STAs (STAs of STA_IDs 1, 3 and 4) carried in the UHR MU PPDU. For STA with STA_ID 2, there are two sets of transmit parameters are indicated in the TXVECTOR. The set of transmit parameters providing higher reliability is assigned to the data stream with higher priority. Advantageously, it improves the targeted throughput and reliability for specific data stream(s).

In the following paragraphs, a second embodiment of the present disclosure is described.

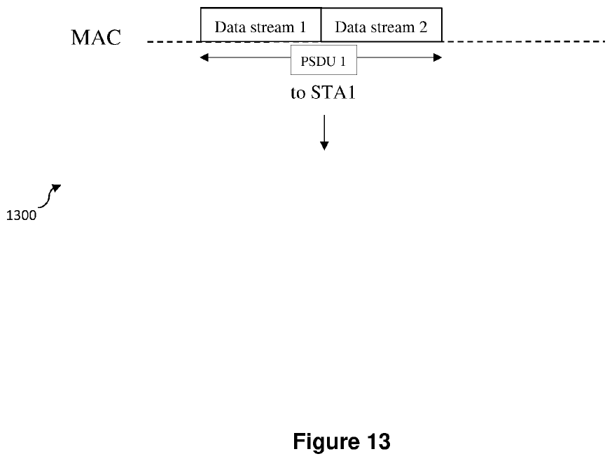

FIG. 13 shows a diagram 1300 illustrating example data streams in a MAC layer according to the second embodiment of the present disclosure. Different data streams (e.g., data stream 1, and data stream 2) targeted at a single STA (e.g., STA 1) are sent from MAC layer to PHY layer together. In particular, both data stream 1 and data stream 2 may be embedded in PSDU 1.

Example primitive used to send the data from MAC layer to PHY layer according to the second embodiment may be as follows:

```
PHY-DATA.request(
  DATA,
  USER_INDEX,
  STA_INDEX
).
```

The MAC layer uses the TXVECTOR to supply PHY layer with per-PPDU transmit parameters (RU allocation, SS allocation MCS, etc.). In the TXVECTOR for the PPDU that will protect a single data stream targeted at a single STA with multiple different transmit parameters, the transmit parameters for the single data stream are indicated. The correspondence between different transmit parameters and different data streams can be indicated in the TXVECTOR. In particular, the PHY entity may transmit the k^{th} (1≤k≤N) 1/N part of the data with the k^{th} set of transmit parameters. The different parts of data can be equally distributed or equally distributed after interleaving.

Table 9 shows details and formats of a parameter in a first exemplary TXVECTOR used to indicate the correspondence between different transmit parameters and different data stream according to the second embodiment of the present disclosure.

TABLE 9

| Parameter | Condition | Value |
|---|---|---|
| STA_ID | FORMAT is | Indicates the list of STA-IDs |
| | UHR_MU | for an UHR MU PPDU. |
| | | Note: the same STA_ID is |
| | | present for same number of |
| | | times as the number of sets |
| | | of transmit parameters. |

Table 10 shows an example table listing out the parameter in the first exemplary TXVECTOR used to indicate the correspondence between different transmit parameters and different data streams targeted at four different STAs (STA_IDs are from 1 to 4) according to the second embodiment of the present disclosure. The two entries of STA_ID 2 indicate that there are two data streams targeted at STA of STA_ID 2 carried in the UHR MU PPDU, and for each of the other STAs (STAs of STA_IDs 1, 3 and 4), the single entry indicates that there is only one data stream targeted at the STA carried in the UHR MU PPDU.

TABLE 10

| | | | | | |
|---|---|---|---|---|---|
| STA_ID | 1 | 2 | 2 | 3 | 4 |

For STA with STA_ID 2, the first ½ part of data is transmitted with the first set of transmit parameters; the second ½ part of data is transmitted with the second set of transmit parameters.

Alternatively, Table 11 shows details and formats of two parameters in a second exemplary TXVECTOR used to indicate the correspondence between different transmit parameters and different data stream according to the second embodiment of the present disclosure.

TABLE 11

| Parameter | Condition | Value |
|---|---|---|
| STA_ID | FORMAT is UHR_MU | Indicates the list of STA-IDs |
| | | for an UHR MU PPDU. |
| NUM_DS | FORMAT is UHR_MU | Indicates the number of |
| | | data streams per STA |
| | | for an UHR MU PPDU. |

Table 12 shows an example table listing out the parameter in the second exemplary TXVECTOR used to implicitly indicate the correspondence between different transmit parameters and different data streams targeted at four different STAs (STA_IDs are from 1 to 4) according to the second embodiment of the present disclosure.

TABLE 12

| | | | | |
|---|---|---|---|---|
| STA_ID | 1 | 2 | 3 | 4 |
| NUM_DS | 1 | 2 | 1 | 1 |

The number of data streams corresponding to each STA_ID is indicated. In particular, it is indicated that there are two data streams targeted at STA of STA_ID 2 carried in the UHR MU PPDU, and one data stream targeted at each of the other STAs (STAs of STA_IDs 1, 3 and 4) carried in the UHR MU PPDU. For STA with STA_ID 2, the first ½ part of data may be transmitted with the first set of transmit parameters; the second ½ part of data may be transmitted with the second set of transmit parameters.

It is noted that the concrete transmit parameters (e.g., MCS) for each priority level of data stream may be implementation dependent. Advantageously, it improves the overall throughput and reliability and less complex than the first embodiment.

In the following paragraphs, a third embodiment of the present disclosure is described.

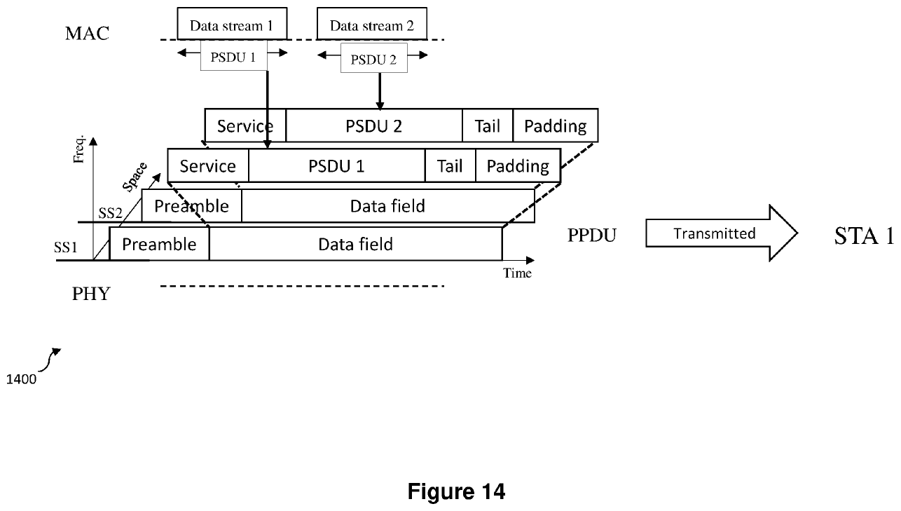

FIG. 14 shows a diagram 1400 illustrating an example transmission procedure according to the third embodiment of the present disclosure. Two data streams (e.g., data stream 1, and data stream 2) targeted at a single STA (e.g., STA1) are sent from MAC layer to PHY layer and embedded to respective PSDUs, for example, data stream 1 is embedded to PSDU 1, and data stream 2 is embedded to PSDU 2. Different sets of transmit parameters may be assigned to different transmission layers in the PPDU carried by different spatial streams and transmitted to the single STA. As shown in FIG. 14, a first set of transmit parameters may be assigned to the transmission layer (i.e., coded packet containing PSDU 1) carried by SS1, and a second set of transmit parameters may be assigned to the transmission layer (i.e., coded packet containing PSDU 1) carried by SS2, so that data stream 1 that is embedded to PSDU1 and data stream 2 that is embedded to PSDU 2 are transmitted to STA1.

When there are multiple sets of transmit parameters assigned to one or more transmission layers targeted at a single STA, each of the transmission layer may contain a single PSDU. If the different transmission layers are carried by different special streams (e.g., MCS is different across SSs assigned to a single STA), the configuration of spatial streams carrying each transmission layer and the corresponding transmit parameters are indicated in preamble.

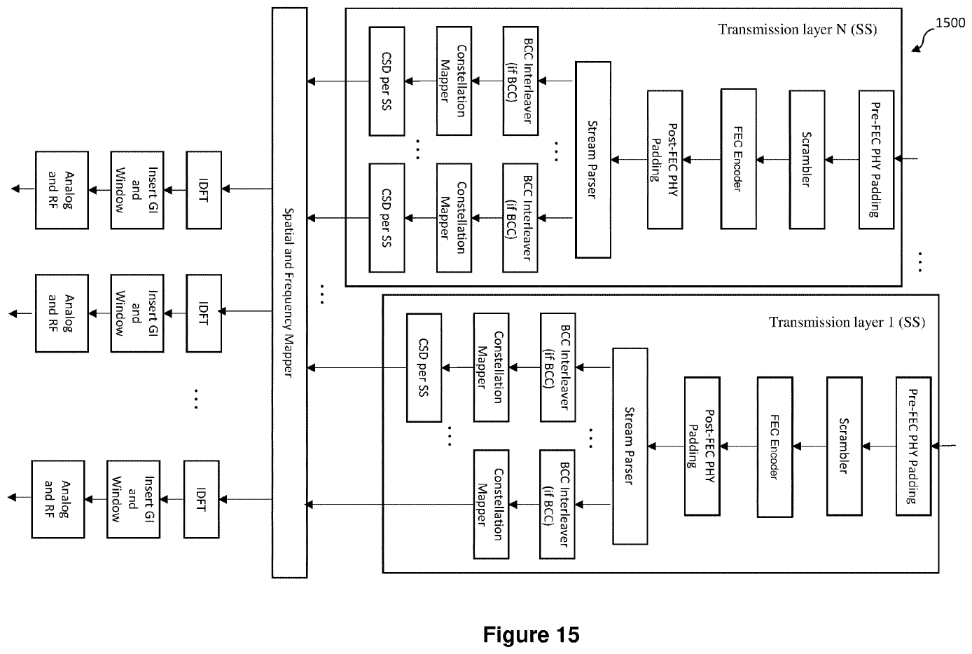

FIG. 15 shows an example transmitter processing 1500 used to process a data field according to the third embodiment of the present disclosure. The transmitter processing may start at each transmission layer (e.g., transmission layers 1-N) carried by a specific SS with its respective Pre-FEC PHY Padding unit where redundant information is added to the data bits before the data is output to a Scrambler for scrambling the data bits to reduce long runs of identical bits on the transmission layer. A FEC encoder unit encodes the data bits before the encoded data is output to a Post-FEC PHY Padding unit to add padding bits such that the number of bits match the number of bits required for a symbol. The transmitter processing 1500 can be the transmitter processing 1100 illustrated in FIG. 11, where the Mapping to Multi-layer Pattern unit 1102 is not implemented or the process by the unit 1102 is skipped.

A Stream Parser unit then divides the encoded bits into multiple blocks that are sent through multiple spatial streams correspondingly. The single spatial stream corresponding to a block of the encoded bits is sent to BCC Interleaver unit which interleaves the bits of each spatial stream (changes order of bits) to prevent long sequences of adjacent noisy bits before it is sent to a Constellation Mapper unit. The Constellation Mapper unit maps respective blocks of the encoded bits into constellation points or complex numbers (herein referred to as modulation symbols) using a selected modulation scheme and ensure respective OFDM subcarriers are separated by a sufficient distance to maximize frequency diversity gain.

Subsequently, the SSs of all transmission layers will be sent to a Spatial and Frequency Mapper unit to map onto multiple transmit chains. Each transmit chain is sent to an Inverse Fourier Discrete Fourier Transform (IDFT) unit. Each IDFT unit converts OFDM subcarriers on the transmit chain, which are frequency-domain data, into time-domain data for transmission. The time-domain data of the IDFT unit is then sent to an Insert Guard Interval (GI) And Window unit to insert GI at the start of each OFDM symbol in the transmit chain where each OFDM symbol may also be windowed to minimize adjacent channel interference. The time-domain data in each transmit chain is then sent to an Analog and Radio Frequency (RF) unit to prepare the data for transmission through an antenna.

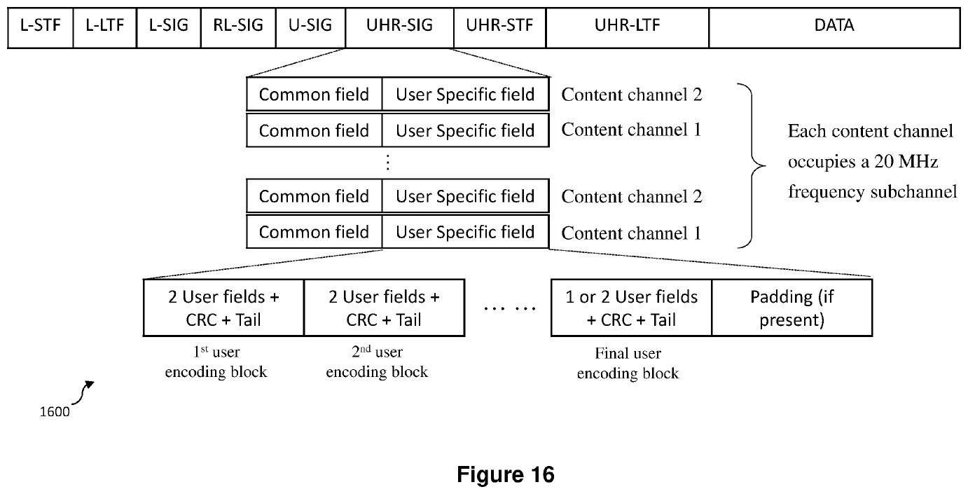

FIG. 16 shows an example UHR PPDU format 1600 for multi-layer transmission according to the third embodiment of the present disclosure. The PPDU 1600 may include a L-STF, a L-LTF, a L-SIG field, a RL-SIG field, a U-SIG field, an UHR-SIG field, a UHR-STF, a UHR-LTF and a Data field. The UHR-SIG field may comprise a content channel occupying each 20 MHz frequency subchannel. Each content channel comprises a Common field and a User Specific field. The User specific field may comprise an encoding block with 2 User Fields, Cyclic Redundancy Check (CRC) bits and Tail bits for each user (e.g., 1^{st} user encoding block), except the final user encoding block comprising 1 or 2 User fields, CRC bits and Tail bits, and padding bits (if needed).

The configuration of spatial streams carrying each transmission layer and the corresponding MCS may be indicated in UHR-SIG field through two different options: (3.1) if there are M transmission layers (where M is an integer, M≥1), there are M User fields specified with the STA-ID of the single STA in the UHR-SIG field; or (3.2) there is only 1 user field specified with the STA-ID of the single STA in the UHR-SIG field.

Different data streams targeted at a single STA may be sent from MAC layer to PHY layer separately to form different PSDUs, according to the first embodiment, when Option 3.1 is applied. In this case, the correspondence between different transmit parameters and different data streams can be explicitly indicated in TXVECTOR when transferring the data from MAC layer to PHY layer. Alternatively, the correspondence between different transmit parameters and different data stream may be implicitly indicated, for example, the configuration of the spatial streams carrying each transmission layer is not indicated in TXVECTOR but the transmit parameters are indicated per level of data stream per STA in TXVECTOR using STA_ID parameter, as illustrated in Table 5 and Table 6. Different data streams targeted at a single STA may be sent from MAC layer to PHY layer together to form one PSDU, according to the second embodiment, when Option 3.1 is applied. In this case, the correspondence between different transmit parameters and different data stream may be implicitly indicated, for example, the configuration of the spatial streams carrying each transmission layer is not indicated in TXVECTOR but the transmit parameters are indicated per level of data stream per STA in TXVECTOR using STA_ID parameter, as illustrated in Table 9 and Table 10.

Similarly, different data streams targeted at a single STA may be sent from MAC layer to PHY layer separately to form different PSDUs, according to the first embodiment, or sent from MAC layer to PHY layer together to form one PSDU, according to the second embodiment, when Option 3.2 is applied. In this case, the correspondence between different transmit parameters and different data stream may be implicitly indicated, for example, the configuration of the spatial streams carrying each transmission layer is not indicated in TXVECTOR but the transmit parameters are indicated per level of data stream per STA in TXVECTOR using STA_ID and NUM_DS parameters, as illustrated in Table 7 and Table 8.

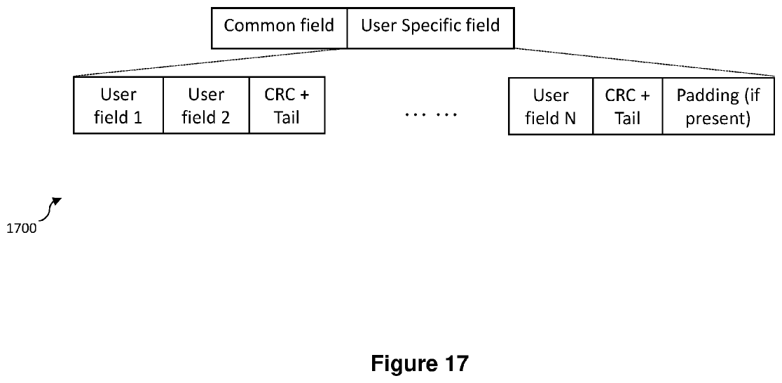

FIG. 17 shows an example UHR-SIG field 1700 of a UHR PPDU according to the third embodiment of the present disclosure. The UHR-SIG field 1700 can be used to indicate the configuration of spatial streams carrying each transmission layer and the corresponding MCS under Option 3.1. The UHR-SIG field 1700 comprises a Common field and a User Specific field in each content channel occupying a 20 MHz frequency subchannel. The User Specific field comprises an encoding block with 2 User Fields, CRC bits and Tail bits for each user (STA-ID), except the final user encoding block, and padding bits (if needed). In this example, the User field 1 and User field 2 can be specified with same STA-ID. In the case of OFDMA transmission, the Common field of the content channel contains a RU Allocation subfield. The mapping of RU allocation subfield and the position of User field to user's assignment may be similar as MU-MIMO transmission in IEEE 802.11be. The RU allocation subfield indicates the number of User fields instead of the number of users. In the case of OFDMA transmission, the Common field of the content channel does not contain a RU Allocation subfield. The Common field indicates the number of non-OFDMA User fields instead of the number of users. It is noted that the number of User fields is indicated to avoid other STAs erroneously decode the RU assignment.

The receiver STA checks all User fields inside the assigned RU in the case of OFDMA transmission or the full content channel in the case of non-OFDMA transmission to find the corresponding User fields with its own STA-ID. This procedure is applicable to both MU-MIMO and non-MU-MIMO transmissions.

Table 13 shows an example encoding of User field of a User Specific field of a UHR PPDU according to the third embodiment of the present disclosure. The User field format for an MU-MIMO allocation can be reused for this purpose.

TABLE 13

| Bit | Subfield | Number of bits |
|---|---|---|
| B0-B10 | STA-ID | 11 |
| B11-B14 | MCS | 4 |
| B15 | Coding | 1 |
| B16-B21 | Spatial Configuration | 6 |

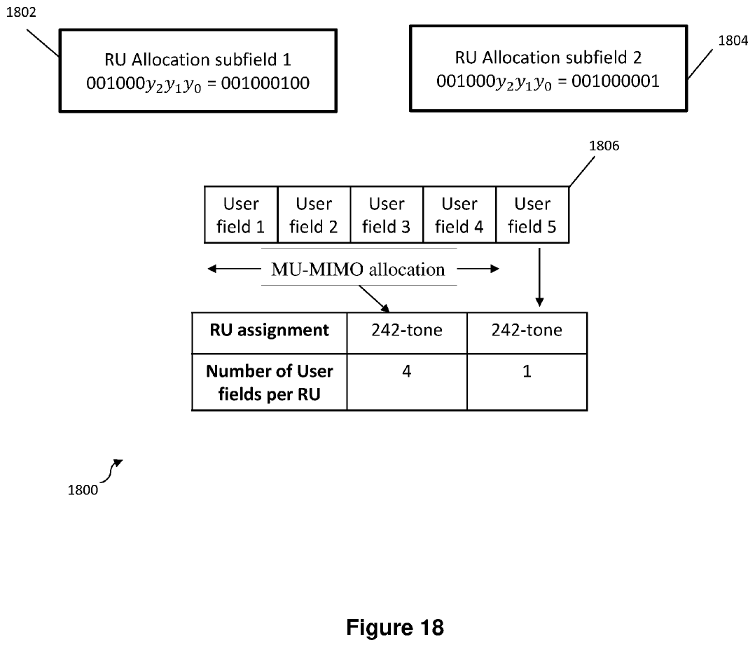

FIG. 18 shows a diagram 1800 illustrating an exemplary mapping of a RU Allocation subfield 1 1802 and a RU Allocation subfield 2 1804 of a Common field and the position of User fields 1806 in a UHR PPDU to user's assignment according to the third embodiment of the present disclosure. In this example, User field 1 and User field 2 are specified with the same STA-ID (in B0-B10 of the fields). For an RU Allocation subfield with value greater than or equal to 64, the first six bits indicates entry to different RU/MRU sizes while the last three bits y2y1y0=000-111 indicates the number of User fields in the UHR-SIG content channel that contains the corresponding 9-bit RU Allocation subfield. The RU Allocation subfield 1 1802 has a value of “001000100” indicating a mapping of 4 User fields per 242-tone RU for MU-MIMO transmission; The RU Allocation subfield 2 1804 has a value of “001000001” indicating 1 User field per 242-tone RU for non-MU-MIMO transmission.

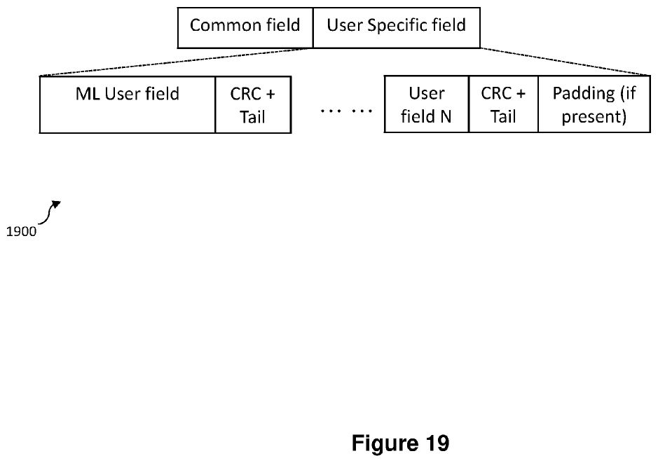

FIG. 19 shows another example UHR-SIG field 1900 of a UHR PPDU according to the third embodiment of the present disclosure. The UHR-SIG field 1900 can be used to indicate the configuration of spatial streams carrying each transmission layer and the corresponding MCS under Option 3.2, where there is only 1 user field specified with the STA-ID of the single STA in the UHR-SIG field. The UHR-SIG field 1900 comprises a Common field and a User Specific field in each content channel occupying a 20 MHz frequency subchannel. The User Specific field comprises a Multi-layer (ML) User field carrying information for multi-layer transmission to a single STA followed by CRC bits and Tail bits and one or more User field (e.g., User field N). The ML User field is specified by a ML STA-ID subfield of the User field. For example, if the value of the ML STA-ID subfield is 2044, the User field is a ML User field; and if the value of the ML STA-ID subfield is an integer smaller than 2008. The length of the ML User field can be double of that of normal User field (i.e., User field format in IEEE 802.11be). The receiver STA may stop checking other User fields when it finds its corresponding User field.

Table 14 shows an example encoding of ML User field for non-MU-MIMO allocation according to the third embodiment of the present disclosure. The ML STA-ID may be always set as 2044 or any value that is reserved in previous IEEE 802.11 amendments to let other STAs know this is an ML User field to avoid the ML User field to be erroneously decoded by other STAs.

TABLE 14

| Bit | Subfield | Number of bits |
|---|---|---|
| B0-B10 | ML STA-ID | 11 |
| B11-B21 | STA-ID | 11 |
| B22-B32 | MCS for Multi-layer | 11 |
| B33-B41 | NSS for Multi-layer | 9 |
| B42 | Beamformed | 1 |
| B43 | Coding | 1 |
| B44 | Reserved | 1 |

Table 15 shows an example encoding of ML User field for MU-MIMO allocation according to the third embodiment of the present disclosure. Some restrictions can be applied to the MCS or NSS for multi-layer transmission to reduce the number of entries to MCS for Multi-layer subfield and NSS for Multi-layer subfield, in order to allow more bits for indicating the Starting Number of SS.

TABLE 15

| Bit | Subfield | Number of bits |
|---|---|---|
| B0-B10 | ML STA-ID | 11 |
| B11-B21 | STA-ID | 11 |
| B22-B29 | MCS for Multi-layer | 8 |
| B30-B38 | NSS for Multi-layer | 9 |
| B39 | Beamformed | 1 |
| B40 | Coding | 1 |
| B41-B44 | Starting Number of SS | 4 |

The ML STA-ID subfield may indicate whether the data transmitted to the STA of STA-ID indicated right after the ML STA-ID subfield of the User field is protected by multiple transmit parameters across SSs. For example, if the value of the ML STA-ID subfield is 2044, the User field is a ML User field; and if the value of the ML STA-ID subfield is an integer smaller than 2008, the User field is a normal User field.

Table 16 shows an example encoding for MCS for Multi-layer (ML) subfield of a ML User field of a UHR PPDU according to the third embodiment of the present disclosure. In this MCS for ML subfield, the MCS for each layer of SSs is indicated. For example, MCS0-15 can be indicated for up to 3 layers using 10 bits.

TABLE 16

| | Modulation | | | Number of |
|---|---|---|---|---|
| Value | Layer 1 | Layer 2 | Layer 3 | Layers |
| 0 | MCSO | MCS1 | — | 2 |
| 1 | MCSO | MCS2 | — | |
| . . . | . . . | . . . | — | |
| 211 | MCSO | MCS1 | MCS2 | 3 |
| 212 | MCSO | MCS2 | MCS3 | |
| . . . | . . . | . . . | . . . | |

| | | |
|---|---|---|
| 2047 | Reserved | Reserved |

Table 17 shows an example encoding for NSS for Multi-layer (ML) subfield of a ML User field of a UHR PPDU according to the third embodiment of the present disclosure. In this NSS for ML subfield, the NSS for each layer of SSs is indicated. For example, total NSS up to 16 can be indicated for up to 3 layers using 9 bits.

TABLE 17

| | NSS | | | Number |
|---|---|---|---|---|
| Value | Layer 1 | Layer 2 | Layer 3 | of Layers |
| 0 | 1 | 1 | — | 2 |
| 1 | 1 | 2 | — | |
| . . . | . . . | . . . | — | |
| 121 | 1 | 1 | 1 | 3 |
| 122 | 1 | 1 | 2 | |
| . . . | . . . | . . . | . . . | |

| | | |
|---|---|---|
| 1023 | Reserved | Reserved |

As mentioned earlier, in the case of OFDMA transmission, the Common field of the content channel contains a RU Allocation subfield; whereas, in the case of OFDMA transmission, the Common field indicates the number of non-OFDMA User fields.

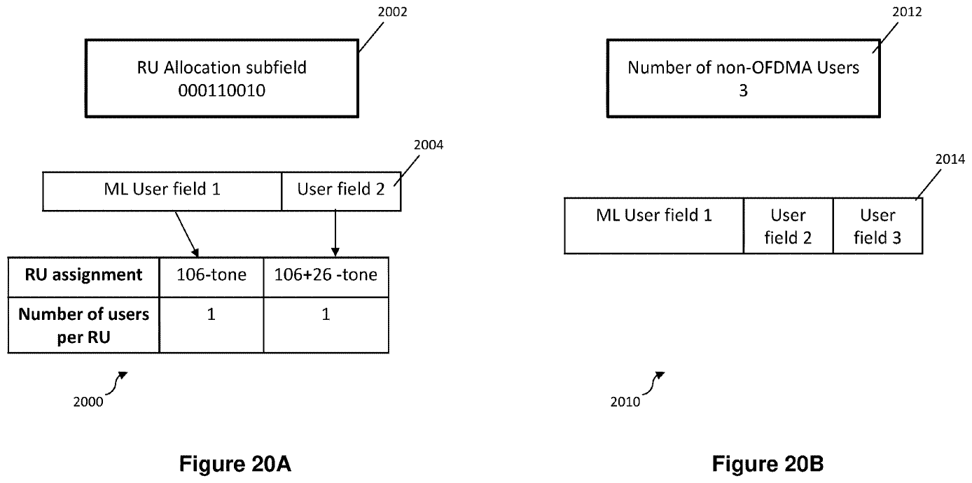

FIG. 20A shows a diagram 2000 illustrating an exemplary mapping of a RU Allocation subfield 2002 of a Common field and the position of ML User field in a UHR PPDU to user's assignment according to the third embodiment of the present disclosure. In this example, the value of RU Allocation subfield 2002 has a value of “000110010” indicating two User fields 2004 with 1 User fields per 106-tone RU followed by 1 User field per 106-tone+26-tone RU being assigned.

FIG. 20B shows a diagram 2010 illustrating an exemplary mapping of a Number of Non-OFDMA User subfield 2010 of a Common field and the position of ML User field in a UHR PPDU to user's assignment according to the third embodiment of the present disclosure. In this example, the number of non-OFDMA Users subfield 2012 indicates there are 3, User fields 2014 in the User Specific field: a ML User field (ML User field 1) and 2 normal User fields (User field 2, User field 3). Other STAs can identify the ML User field by decoding the ML STA-ID to find the corresponding RU/MRU assignment.

In the following paragraphs, a fourth embodiment of the present disclosure, where different transmission layers carrying PSDUs targeted at a single STA is carried by different resource units, is described.

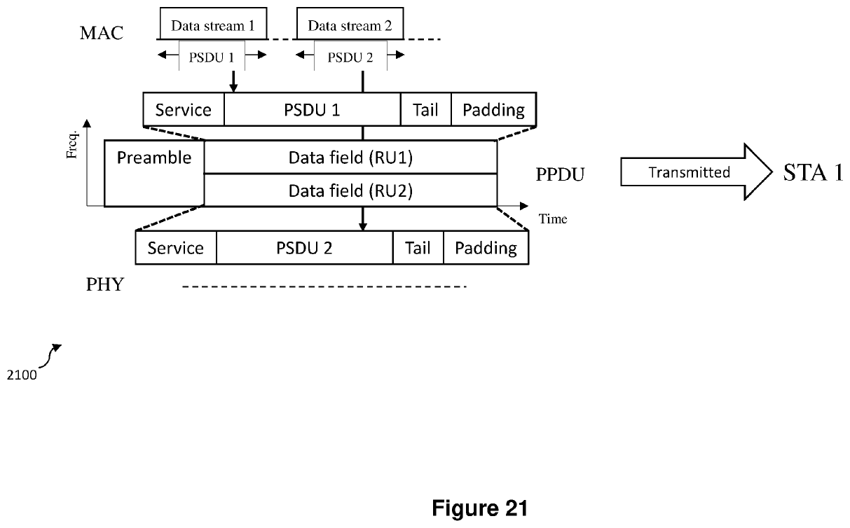

FIG. 21 shows a diagram 2100 illustrating an example transmission procedure according to the fourth embodiment of the present disclosure. Two data streams (e.g., data stream 1, and data stream 2) targeted at a single STA (e.g., STA1) are sent from MAC layer to PHY layer and embedded to respective PSDUs, for example, data stream 1 is embedded to PSDU 1, and data stream 2 is embedded to PSDU 2. Different sets of transmit parameters may be assigned to different transmission layers in the PPDU carried by different RU/MRUs (e.g., RU1 and RU2) and transmitted to the single STA. As shown in FIG. 21, a first set of transmit parameters may be assigned to the transmission layer (i.e., coded packet containing PSDU 1) carried by RU1, and a second set of transmit parameters may be assigned to the transmission layer (i.e., coded packet containing PSDU 1) carried by RU2, so that data stream 1 that is embedded to PSDU1 and data stream 2 that is embedded to PSDU 2 are transmitted to STA1.

When there are multiple sets of transmit parameters assigned to one or more transmission layers targeted at a single STA, each of the transmission layer may contain a single PSDU. If the different transmission layers are carried by different RU/MRUs (e.g., MCS is different across RU/MRUs assigned to a single STA), the RU/MRU carrying each transmission layer and the corresponding transmit parameters are indicated in preamble. This embodiment of the present disclosure is only applicable to OFDMA transmission.

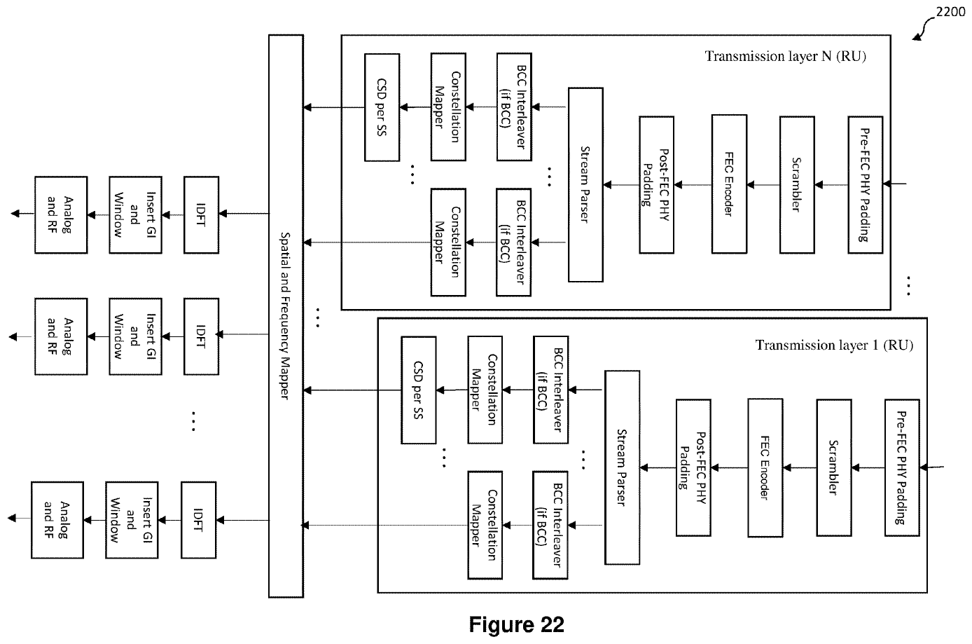

FIG. 22 shows an example transmitter processing 2200 used to process a data field according to various embodiments of the present disclosure. The transmitter processing may start at each transmission layer (e.g., transmission layers 1-N) carried by a specific RU with its respective Pre-FEC PHY Padding unit where redundant information is added to the data bits before the data is output to a Scrambler for scrambling the data bits to reduce long runs of identical bits on the transmission layer. A FEC encoder unit encodes the data bits before the encoded data is output to a Post-FEC PHY Padding unit to add padding bits such that the number of bits match the number of bits required for a symbol. The transmitter processing 2200 can be the transmitter processing 1100 illustrated in FIG. 11, where the Mapping to Multi-layer Pattern unit 1102 is not implemented or the process by the unit 1102 is skipped.

A Stream Parser unit then divides the encoded bits into multiple blocks that are sent through multiple spatial streams correspondingly. The single spatial stream corresponding to a block of the encoded bits is sent to BCC Interleaver unit which interleaves the bits of each spatial stream (changes order of bits) to prevent long sequences of adjacent noisy bits before it is sent to a Constellation Mapper unit. The Constellation Mapper unit maps respective blocks of the encoded bits into constellation points or complex numbers (herein referred to as modulation symbols) using a selected modulation scheme and ensure respective OFDM subcarriers are separated by a sufficient distance to maximize frequency diversity gain.

Subsequently, the SSs of all transmission layers will be sent to a Spatial and Frequency Mapper unit to map onto multiple transmit chains. Each transmit chain is sent to an Inverse Fourier Discrete Fourier Transform (IDFT) unit. Each IDFT unit converts OFDM subcarriers on the transmit chain, which are frequency-domain data, into time-domain data for transmission. The time-domain data of the IDFT unit is then sent to an Insert Guard Interval (GI) And Window unit to insert GI at the start of each OFDM symbol in the transmit chain where each OFDM symbol may also be windowed to minimize adjacent channel interference. The time-domain data in each transmit chain is then sent to an Analog and Radio Frequency (RF) unit to prepare the data for transmission through an antenna.

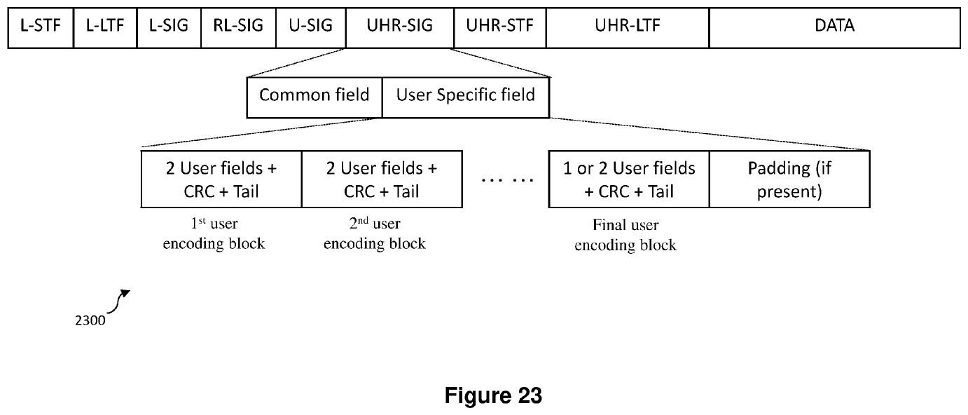

FIG. 23 shows an example UHR PPDU format 2300 for multi-layer transmission according to the fourth embodiment of the present disclosure. The PPDU 2300 may include a L-STF, a L-LTF, a L-SIG field, a RL-SIG field, a U-SIG field, an UHR-SIG field, a UHR-STF, a UHR-LTF and a Data field. The UHR-SIG field comprises a content channel occupying each 20 MHz frequency subchannel. Each content channel comprises a Common field and a User Specific field. The User specific field comprises an encoding block with 2 User Fields, Cyclic Redundancy Check (CRC) bits and Tail bits for each user (e.g., 1^{st} user encoding block), except the final user encoding block comprising 1 or 2 User fields, CRC bits and Tail bits, and padding bits (if needed). In this embodiment, more than one RU/MRU can be assigned to the same STA.

The configuration of RU/MRUs carrying each transmission layer and the corresponding MCS may be indicated in UHR-SIG field through two different options: (4.1) if there are M transmission layers (where M is an integer, M≥1), there are M User fields specified with the STA-ID of the single STA in the UHR-SIG field; or (4.2) there is only 1 user field specified with the STA-ID of the single STA in the UHR-SIG field. The indication of MCS corresponding to the RU/MRU carrying each transmission layer may be combined with MRU allocation under Option 4.2.

Different data streams targeted at a single STA may be sent from MAC layer to PHY layer separately to form different PSDUs, according to the first embodiment, when Option 4.1 is applied. In this case, the correspondence between different transmit parameters and different data streams can be explicitly indicated in TXVECTOR when transferring the data from MAC layer to PHY layer. Alternatively, the correspondence between different transmit parameters and different data stream may be implicitly indicated, for example, the configuration of the RU/MRUs carrying each transmission layer is not indicated in TXVECTOR but the transmit parameters are indicated per level of data stream per STA in TXVECTOR using STA_ID parameter, as illustrated in Table 5 and Table 6. Different data streams targeted at a single STA may be sent from MAC layer to PHY layer together to form one PSDU, according to the second embodiment, when Option 4.1 is applied. In this case, the correspondence between different transmit parameters and different data stream may be implicitly indicated, for example, the configuration of the RU/MRUs carrying each transmission layer is not indicated in TXVECTOR but the transmit parameters are indicated per level of data stream per STA in TXVECTOR using STA_ID parameter, as illustrated in Table 9 and Table 10.

Similarly, different data streams targeted at a single STA may be sent from MAC layer to PHY layer separately to form different PSDUs, according to the first embodiment, or sent from MAC layer to PHY layer together to form one PSDU, according to the second embodiment, when Option 4.2 is applied. In this case, the correspondence between different transmit parameters and different data stream may be implicitly indicated, for example, the configuration of the RU/MRUs carrying each transmission layer is not indicated in TXVECTOR but the transmit parameters are indicated per level of data stream per STA in TXVECTOR using STA_ID and NUM_DS parameters, as illustrated in Table 67 and Table 8.

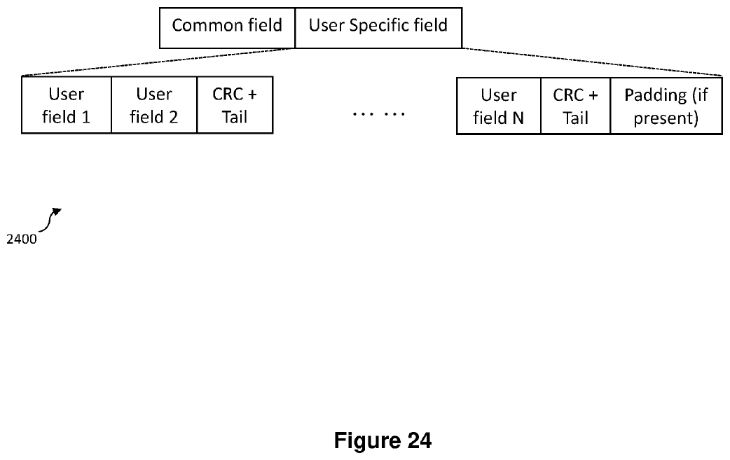

FIG. 24 shows an example UHR-SIG field 2400 of a UHR PPDU according to the fourth embodiment of the present disclosure. The UHR-SIG field 2400 can be used to indicate the configuration of RU/MRUs carrying each transmission layer and the corresponding MCS under Option 4.1. The UHR-SIG field 2400 comprises a Common field and a User Specific field in each content channel occupying a 20 MHz frequency subchannel. The User Specific field comprises an encoding block with 2 User Fields, CRC bits and Tail bits for each user (STA-ID), except the final user encoding block, and padding bits (if needed). In this example, the User field 1 and User field 2 can be specified with same STA-ID.

The receiver STA shall check all User fields to find the corresponding User field(s) with its own STA-ID. This procedure is applicable to a non-MU-MIMO transmission. Table 18 shows an example encoding of User field of a User Specific field of a UHR PPDU according to the fourth embodiment of the present disclosure. The User field format for a non-MU-MIMO allocation can be reused for this purpose.

TABLE 18

| Bit | Subfield | Number of bits |
|---|---|---|
| B0-B10 | STA-ID | 11 |
| B11-B14 | MCS | 4 |
| B15 | Reserved | 1 |
| B16-B19 | NSS | 4 |
| B20 | Beamformed | 1 |
| B21 | Coding | 1 |

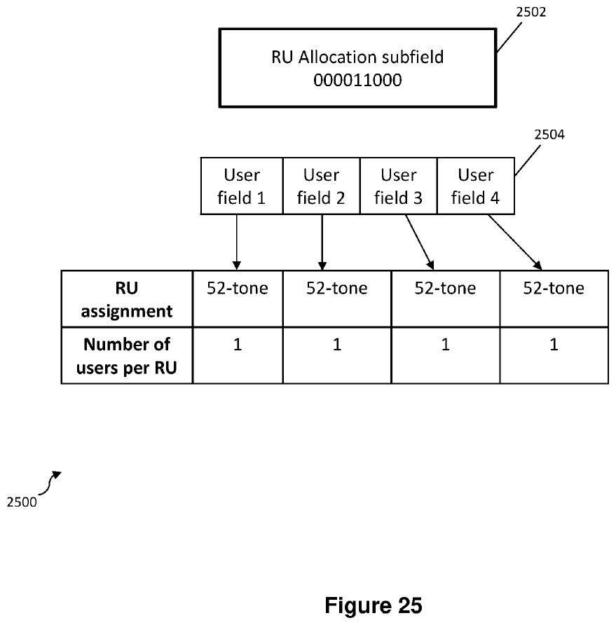

FIG. 25 shows a diagram 2500 illustrating an exemplary mapping of a RU Allocation subfield 2502 of a Common field and the position of User fields 2504 in a UHR PPDU to user's assignment according to the fourth embodiment of the present disclosure. In this example, User field 1 and User field 2 are specified with the same STA-ID (in B0-B10 of the fields). The RU Allocation subfield 2504 has a value of “000011000” indicating a mapping of 1 User field per 52-tone RU for each of the User fields 1-4.

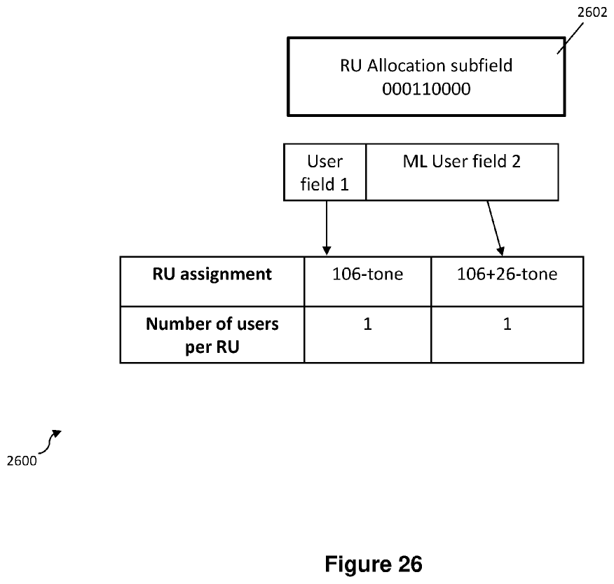

FIG. 26 shows another example UHR-SIG field 2600 of a UHR PPDU according to the fourth embodiment of the present disclosure. The UHR-SIG field 2600 can be used to indicate the configuration of RU/MRUs carrying each transmission layer and the corresponding MCS under Option 4.2, where there is only 1 user field specified with the STA-ID of the single STA in the UHR-SIG field. The UHR-SIG field 2600 comprises a Common field and a User Specific field in each content channel occupying a 20 MHz frequency subchannel. The User Specific field comprises a Multi-layer (ML) User field carrying information for multi-layer transmission to a single STA followed by CRC bits and Tail bits and one or more User field (e.g., User field N). The ML User field is specified by a ML STA-ID subfield of the User field. For example, the ML STA-ID subfield is always set as 2044 to let other STAs know this is an ML User field. The length of the ML User field can be double of that of normal User field (i.e., User field format in IEEE 802.11be). The receiver STA may stop checking other User fields when it finds its corresponding User field. The ML User field format of the UHR-SIG field 2600 is illustrated in Table 14.

The ML STA-ID subfield may indicate whether the data transmitted to the STA of STA-ID indicated right after the ML-STA-ID subfield of the User field is protected by multiple transmit parameters across RU/MRUs. The encoding for MCS for ML subfield and NSS for ML subfield of the ML User field of the UHR-SIG field 2600 is illustrated in Table 16 and Table 17, respectively.

In the following paragraphs, a fifth embodiment of the present disclosure, where different transmission layers carrying PSDUs targeted at a single STA is carried by different time units, is described.

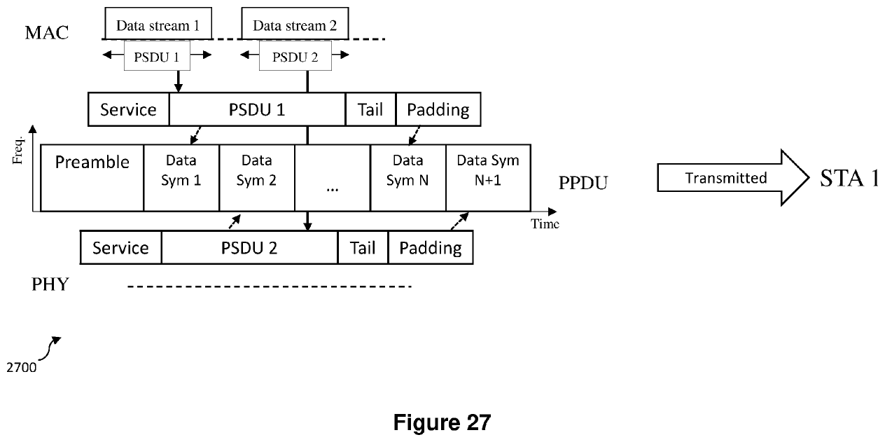

FIG. 27 shows a diagram 2700 illustrating an example transmission procedure according to the fifth embodiment of the present disclosure. Two data streams (e.g., data stream 1 and data stream 2) targeted at a single STA (e.g., STA1) are sent from MAC layer to PHY layer and embedded to respective PSDUs, for example, data stream 1 is embedded to PSDU 1, and data stream 2 is embedded to PSDU 2. Different sets of transmit parameters may be assigned to different transmission layers in the PPDU carried by different time units and transmitted to the single STA. As shown in FIG. 27, a first set of transmit parameters may be assigned to the transmission layer (i.e., coded packet containing PSDU 1) carried by data symbols from Data Symbol 1 to Data Symbol N, and a second set of transmit parameters may be assigned to the transmission layer (i.e., coded packet containing PSDU 1) carried by data symbols from Data Symbol 1 to Data Symbol N, so that data stream 1 that is embedded to PSDU1 and data stream 2 that is embedded to PSDU 2 are transmitted to STA1.

When there are multiple sets of transmit parameters assigned to one or more PSDUs targeted at a single STA and the different transmission layers are carried by different time units (e.g., MCS is different across OFDM symbols sent to a single STA), the time units carrying each transmission layer and the corresponding transmit parameters are indicated in preamble.

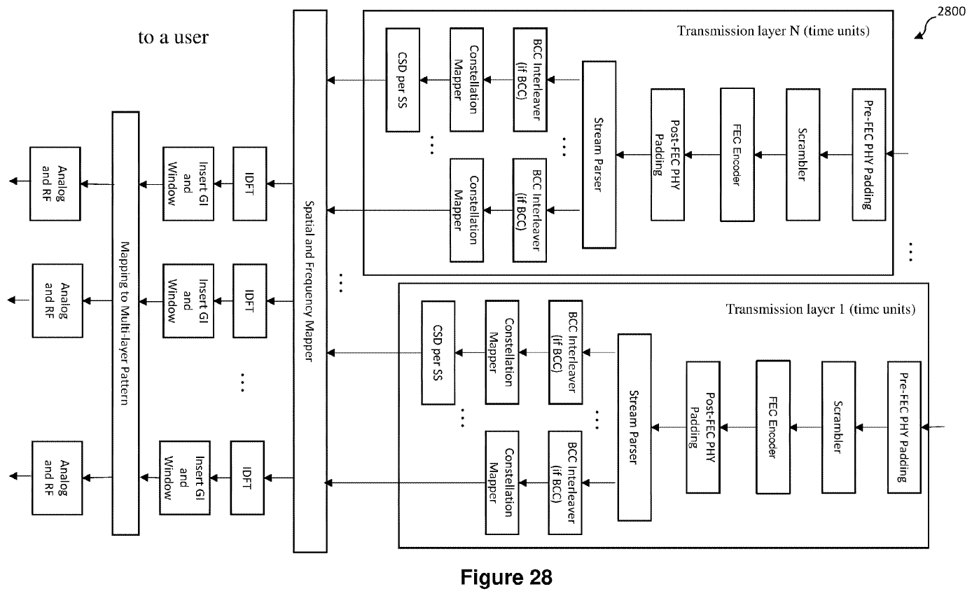

FIG. 28 shows an example transmitter processing 2800 used to process a data field according to the fifth embodiment of the present disclosure. The transmitter processing may start at each transmission layer (e.g., transmission layers 1-N) carried by a specific RU with its respective Pre-FEC PHY Padding unit where redundant information is added to the data bits before the data is output to a Scrambler for scrambling the data bits to reduce long runs of identical bits on the transmission layer. A FEC encoder unit encodes the data bits before the encoded data is output to a Post-FEC PHY Padding unit to add padding bits such that the number of bits match the number of bits required for a symbol. The transmitter processing 1500 can be the transmitter processing 1100 illustrated in FIG. 11.

A Stream Parser unit then divides the encoded bits into multiple blocks that are sent through multiple spatial streams correspondingly. The single spatial stream corresponding to a block of the encoded bits is sent to BCC Interleaver unit which interleaves the bits of each spatial stream (changes order of bits) to prevent long sequences of adjacent noisy bits before it is sent to a Constellation Mapper unit. The Constellation Mapper unit maps respective blocks of the encoded bits into constellation points or complex numbers (herein referred to as modulation symbols) using a selected modulation scheme and ensure respective OFDM subcarriers are separated by a sufficient distance to maximize frequency diversity gain.

Subsequently, the SSs of all transmission layers will be sent to a Spatial and Frequency Mapper unit to map onto multiple transmit chains. Each transmit chain is sent to an Inverse Fourier Discrete Fourier Transform (IDFT) unit. Each IDFT unit converts OFDM subcarriers on the transmit chain, which are frequency-domain data, into time-domain data for transmission. The time-domain data of the IDFT unit is then sent to an Insert Guard Interval (GI) And Window unit to insert GI at the start of each OFDM symbol in the transmit chain where each OFDM symbol may also be windowed to minimize adjacent channel interference. The time-domain data in each transmit chain is then sent to a Mapping to Multi-layer Pattern unit to map different symbols of each transmit chain to different transmission layers before sending it to an Analog and Radio Frequency (RF) unit to prepare the data for transmission through an antenna.

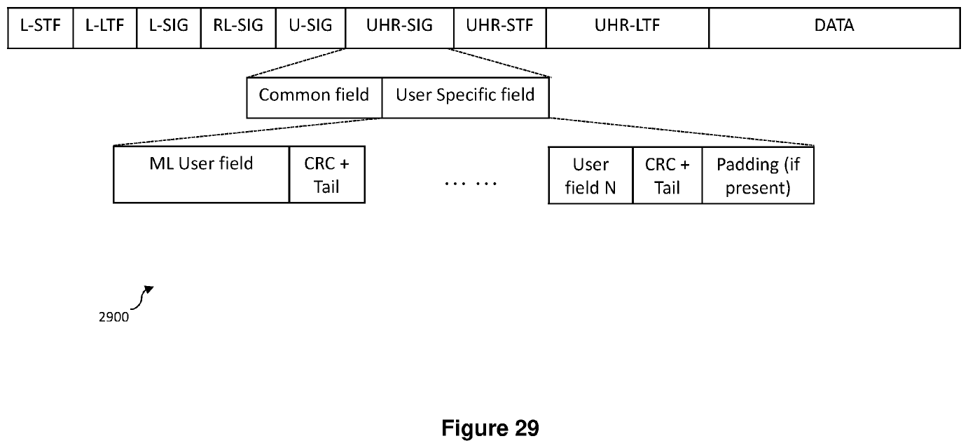

FIG. 29 shows an example UHR PPDU format 2900 for multi-layer transmission according to the fifth embodiment of the present disclosure. The PPDU 2900 may include a L-STF, a L-LTF, a L-SIG field, a RL-SIG field, a U-SIG field, an UHR-SIG field, a UHR-STF, a UHR-LTF and a Data field. The UHR-SIG field comprises a content channel occupying each 20 MHz frequency subchannel. Each content channel comprises a Common field and a User Specific field. The User specific field comprises an encoding block with 1 User field (e.g., mL User field or normal User field) normal User Field with Cyclic Redundancy Check (CRC) bits and Tail bits for each user and padding bits (if needed).

In the case of OFDMA or non-OFMDA transmission, the configuration of spatial streams carrying each transmission layer and the corresponding MCS and other transmit parameters may be indicated in UHR-SIG field. There is only 1 user field specified with the STA-ID of the single STA in the UHR-SIG field. The ML User field is specified by a ML Flag subfield of the User field. The User field carrying information for Multi-layer transmission to the single STA is a ML User field. The receiver STA may stop checking other User fields when it finds the corresponding User field. The length of the ML User field can be double of that of normal User field (i.e., User field format in IEEE 802.11be).

Different data streams targeted at a single STA may be sent from MAC layer to PHY layer separately to form different PSDUs, according to the first embodiment, or sent from MAC layer to PHY layer together to form one PSDU, according to the second embodiment. The correspondence between different transmit parameters and different data stream may be implicitly indicated, for example, the configuration of the spatial streams carrying each transmission layer is not indicated in TXVECTOR but the transmit parameters are indicated per level of data stream per STA in TXVECTOR using STA_ID and NUM_DS parameters, as illustrated in Table 7 and Table 8.

Table 19 shows an example encoding of ML User field for non-MU-MIMO allocation according to the fifth embodiment of the present disclosure.

TABLE 19

| Bit | Subfield | Number of bits |
|---|---|---|
| B0-B10 | ML STA-ID | 11 |
| B11-B21 | STA-ID | 11 |
| B22-B29 | MCS for Multi-layer | 8 |
| B30-B36 | NSS for Multi-layer | 7 |
| B37-B39 | Multi-layer Pattern | 3 |
| B40 | Beamformed | 1 |
| B41 | Coding | 1 |
| B42-B43 | Reserved | 2 |

Table 20 shows an example encoding of ML User field for MU-MIMO allocation according to the third embodiment of the present disclosure.

TABLE 20

| Bit | Subfield | Number of bits |
|---|---|---|
| B0-B10 | ML STA-ID | 11 |
| B11-B21 | STA-ID | 11 |
| B22-B29 | MCS for Multi-layer | 8 |
| B30-B36 | NSS for Multi-layer | 7 |
| B37-B39 | Multi-layer Pattern | 3 |
| B40 | Beamformed | 1 |
| B41 | Coding | 1 |
| B42-B43 | Starting Number of SS | 2 |

The ML STA-ID subfield indicates whether the data transmitted to the STA of STA-ID indicated right after the ML STA-ID subfield of the User field is protected by multiple transmit parameters across time units. The MCS for Multi-layer subfield and NSS for Multi-layer subfield indicates the MCS and NSS for each layer of time units. (The encoding can be same as that illustrated in Table 16 and Table 17). The Multi-layer Pattern subfield indicates the pattern of multi-layer time units that applies to the data part of the PPDU.

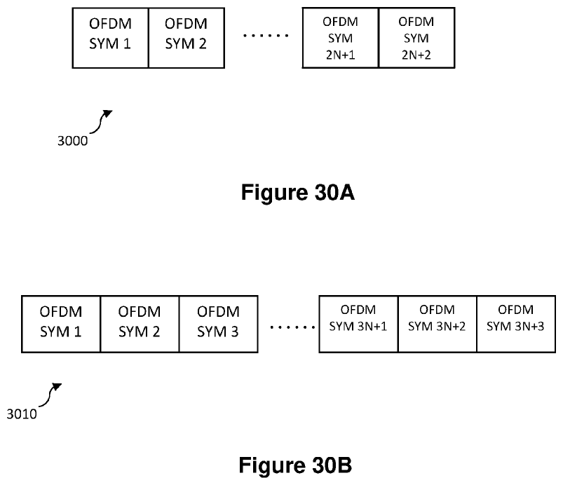

FIG. 30A shows a diagram 3000 illustrating a first example pattern of multi-layer time units according to the fifth embodiment of the present disclosure. The data carried by the assigned RU/MRU across (2N+1)^{th} OFDM symbols is the 1^{st} transmission layer; the data carried by the assigned RU/MRU across (2N+2)^{th} OFDM symbols is the 2^{nd} transmission layer, where N≥0).

FIG. 30B shows a diagram 3010 illustrating a second example pattern of multi-layer time units according to the fifth embodiment of the present disclosure. The data carried by the assigned RU/MRU across (3N+1)^{th} and (3N+2)^{th} OFDM symbols is the 1^{st} transmission layer; the data carried by the assigned RU/MRU across (3N+3)^{th} OFDM symbols is the 2^{nd} transmission layer, where N≥0).

In the following paragraphs, a sixth embodiment of the present disclosure, where different transmission layers carrying PSDUs targeted at a single STA is carried by different combinations of SSs, resource units and time units, is described.

When there are multiple sets of transmit parameters assigned to one or more PSDUs targeted at a single STA and the different transmission layers are carried in mixed mode (e.g., MCS is different across SSs, RU/MRUs and time units sent to a single STA), the detailed way (i.e., the combination of different SSs, RU/MRUs and time units) carrying each transmission layer and the corresponding transmit parameters are indicated in preamble. In a mixed mode, the transmission layer can be carried by more than one dimensions. The different transmission layer options under the mixed mode are shown in Table 21.

TABLE 21

| Transmission layer options | Meaning |
|---|---|
| RU + SS | Transmit parameters are |
| | different across SSs of |
| | different RU/MRUs sent |
| | to a single STA. |
| RU + time units | Transmit parameters are |
| | different across RU/MRUs of |
| | different time units sent |
| | to a single STA. |
| Time units + SS | Transmit parameters are |
| | different across SSs of |
| | different time units sent |
| | to a single STA. |
| RU + SS + | Transmit parameters are |
| time units | different across SSs of |
| | RU/MRUSs of different time units |
| | sent to a single STA. |

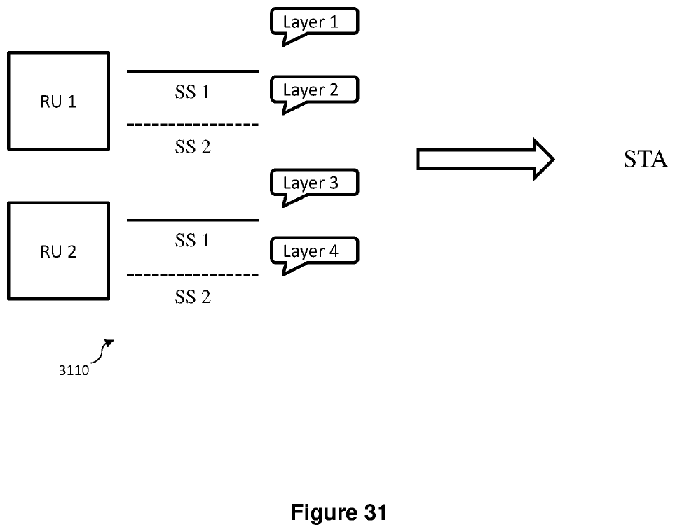

FIG. 31 shows a diagram 3100 illustrating example transmission layers under a mixed mode of RU and SS according to the sixth embodiment of the present disclosure. In this example, the transmit parameters is different across SSs of different RU/MRUs sent to a single STA. In particular, two RUs (RU1, RU2) are assigned to a single STA and 2 SSs (SS1, SS2) are assigned to each RU. Therefore, there can be four transmission layers, that is, layer 1 which is carried in SS1 of RU1; layer 2 which is carried in SS2 of RU1; layer 3 which is carried in SS1 or RU2; and layer 4 which is carried in SS2 of RU2.

For mixed mode of SS and RU, the signalling designs such as the UHR PPDU format, UHR-SIG field format, User field format, mapping of RU Allocation subfield and the position of User field, ML User field format, MCS for ML subfield format, NSS for ML subfield format for the third and fourth embodiments, as illustrated in FIGS. 16-20B and 23-26, where different transmission layers carrying PSDUs targeted at a single STA is carried by different SSs and RUs, respectively, can be used.

The configuration of SSs and RUs carrying each transmission layer and the corresponding MCS may be indicated in UHR-SIG field through two different options: (6.1) if there are M transmission layers (where M is an integer, M≥1), there are M User fields specified with the STA-ID of the single STA in the UHR-SIG field; or (6.2) there is only 1 user field specified with the STA-ID of the single STA in the UHR-SIG field.

Different data streams targeted at a single STA may be sent from MAC layer to PHY layer separately to form different PSDUs, according to the first embodiment, when Option 6.1 is applied. In this case, the correspondence between different transmit parameters and different data streams can be explicitly indicated in TXVECTOR when transferring the data from MAC layer to PHY layer. Alternatively, the correspondence between different transmit parameters and different data stream may be implicitly indicated, for example, the configuration of the SSs and RUs carrying each transmission layer is not indicated in TXVECTOR but the transmit parameters are indicated per level of data stream per STA in TXVECTOR using STA_ID parameter, as illustrated in Table 5 and Table 6. Different data streams targeted at a single STA may be sent from MAC layer to PHY layer together to form one PSDU, according to the second embodiment, when Option 6.1 is applied. In this case, the correspondence between different transmit parameters and different data stream may be implicitly indicated, for example, the configuration of the SSs and RUs carrying each transmission layer is not indicated in TXVECTOR but the transmit parameters are indicated per level of data stream per STA in TXVECTOR using STA_ID parameter, as illustrated in Table 9 and Table 10.

Similarly, different data streams targeted at a single STA may be sent from MAC layer to PHY layer separately to form different PSDUs, according to the first embodiment, or sent from MAC layer to PHY layer together to form one PSDU, according to the second embodiment, when Option 6.2 is applied. In this case, the correspondence between different transmit parameters and different data stream may be implicitly indicated, for example, the configuration of the SSs and RUs carrying each transmission layer is not indicated in TXVECTOR but the transmit parameters are indicated per level of data stream per STA in TXVECTOR using STA_ID and NUM_DS parameters, as illustrated in Table 7 and Table 8.

For mixed mode of R^{U} and time units, the signalling designs such as the UHR PPDU format, UHR-SIG field format, User field format, mapping of RU Allocation subfield and the position of User field, ML User field format, MCS for ML subfield format, NSS for ML subfield format for the third and fifth embodiments, as illustrated in FIGS. 23-26 and 29-30B, where different transmission layers carrying PSDUs targeted at a single STA is carried by different RUs and time units, respectively, can be used.

Different data streams targeted at a single STA may be sent from MAC layer to PHY layer separately to form different PSDUs, according to the first embodiment, or sent from MAC layer to PHY layer together to form one PSDU, according to the second embodiment. The correspondence between different transmit parameters and different data stream may be implicitly indicated, for example, the configuration of the spatial streams carrying each transmission layer is not indicated in TXVECTOR but the transmit parameters are indicated per level of data stream per STA in TXVECTOR using STA_ID and NUM_DS parameters, as illustrated in Table 7 and Table 8.

For mixed mode of SSs and time units, the signalling designs such as the UHR PPDU format, UHR-SIG field format, User field format, mapping of RU Allocation subfield and the position of User field, ML User field format, MCS for ML subfield format, NSS for ML subfield format for the third and fifth embodiments, as illustrated in FIGS. 16-20B and 29-30B, where different transmission layers carrying PSDUs targeted at a single STA is carried by different SSs and time units, respectively, can be used.

Different data streams targeted at a single STA may be sent from MAC layer to PHY layer separately to form different PSDUs, according to the first embodiment, or sent from MAC layer to PHY layer together to form one PSDU, according to the second embodiment. The correspondence between different transmit parameters and different data stream may be implicitly indicated, for example, the configuration of the spatial streams carrying each transmission layer is not indicated in TXVECTOR but the transmit parameters are indicated per level of data stream per STA in TXVECTOR using STA_ID and NUM_DS parameters, as illustrated in Table 7 and Table 8.

For mixed mode of SSs, RUs and time units, the signalling designs such as the UHR PPDU format, UHR-SIG field format, User field format, mapping of RU Allocation subfield and the position of User field, ML User field format, MCS for ML subfield format, NSS for ML subfield format for the third and fifth embodiments, as illustrated in FIGS. 16-20B, 23-26 and 29-30B, where different transmission layers carrying PSDUs targeted at a single STA is carried by different SSs, RUs and time units, respectively, can be used.

Different data streams targeted at a single STA may be sent from MAC layer to PHY layer separately to form different PSDUs, according to the first embodiment, or sent from MAC layer to PHY layer together to form one PSDU, according to the second embodiment. The correspondence between different transmit parameters and different data stream may be implicitly indicated, for example, the configuration of the spatial streams carrying each transmission layer is not indicated in TXVECTOR but the transmit parameters are indicated per level of data stream per STA in TXVECTOR using STA_ID and NUM_DS parameters, as illustrated in Table 7 and Table 8.

The present disclosure can be realized by software, hardware, or software in cooperation with hardware. Each functional block used in the description of each embodiment described above can be partly or entirely realized by an LSI such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system on a chip (SoC), a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, an FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus.

Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IOT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It will be understood that while some properties of the various embodiments have been described with reference to a device, corresponding properties also apply to the methods of various embodiments, and vice versa.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

1. A first communication apparatus comprising:
a module, which, in operation, is configured to generate a signal comprising two or more transmission layers, each of the two or more transmission layers carrying a data stream, wherein the data streams carried in the two or more transmission layers are configured with different sets of transmit parameters but directed to a single second communication apparatus; and
a transmitter, which, in operation, transmits the signal to the single second communication apparatus.

2. The first communication apparatus of claim 1, wherein a first sub-module of the module is configured to separately process and embed each of the two or more data streams into a part of the signal to generate the signal.

3. The first communication apparatus of claim 2, wherein a second sub-module of the module is configured to report a priority level of each of the data streams to be carried in the two or more transmission layers together with the data streams to the first sub-module of the module, wherein the first sub-module of the module is configured to generate the signal according to the indicated priority levels of the reported data streams.

4. The first communication apparatus of claim 1, wherein a second sub-module of the module is configured to indicate the different sets of transmit parameters for the data streams to be carried in the two or more transmission layers to a first sub-module of the module using primitives, wherein the first sub-module of the module is configured to generate the signal using the indicated sets of transmit parameters.

5. The first communication apparatus of claim 4, wherein the primitive comprises two or more instances of an identification of the single second communication apparatus, wherein a number of the two or more instances of the identification of the single second communication apparatus corresponds to one of a number of the data streams and a number of the different sets of transmit parameters configured for the data streams directed to the single second communication apparatus.

6. The first communication apparatus of claim 1, wherein the signal comprises one first signal field indicating a configuration of at least one of respective spatial streams, resource units and time units carrying the two or more transmission layers and respective sets of transmit parameters corresponding to the two or more transmission layers, and wherein the transmitter transmits the signal to the single second communication apparatus based on the configuration.

7. The first communication apparatus of claim 1, wherein the one first signal field further comprising a signal subfield, the signal subfield indicating a presence of the configuration of the at least one of the respective spatial streams, resource units and time units carrying the two or more transmission layers and the respective sets of transmit parameters corresponding to the two or more transmission layers.

8. The first communication apparatus of claim 1, wherein the signal comprises two or more first signal fields, wherein a number of the two or more first signal fields corresponds to a number of the two or more transmission layers, and each of the two or more first signal fields indicates a configuration of at least one of a spatial stream, a resource unit and a time unit carrying one of the two or more transmission layers, and wherein the transmitter transmits the signal to the single second communication apparatus based on the configuration.

9. The first communication apparatus of claim 8, wherein the signal further comprises a second signal field indicating the number of two or more first signal fields.

10. A second communication apparatus comprising:
a receiver, which, in operation, receives a signal from a first communication apparatus, the signal comprising two or more transmission layers, each of the two or more transmission layers carrying a data stream, wherein the data streams carried in the two or more transmission layers are configured with different sets of transmit parameters but directed to the second communication apparatus; and
a module, which, in operation, is configured to process and decode the signal.

11. The second communication apparatus of claim 10, wherein the signal comprises one first signal field indicating a configuration of at least one of respective spatial streams, resource units and time units carrying the two or more transmission layers and respective sets of transmit parameters corresponding to the two or more transmission layers, and wherein the transmitter transmits the signal to the single second communication apparatus based on the configuration.

12. The second communication apparatus of claim 10, wherein the one first signal field further comprising a signal subfield, the signal subfield indicating a presence of the configuration of the at least one of the respective spatial streams, resource units and time units carrying the two or more transmission layers and the respective sets of transmit parameters corresponding to the two or more transmission layers.

13. The second communication apparatus of claim 10, wherein the signal comprises two or more first signal fields, wherein a number of the two or more first signal fields corresponds to a number of the two or more transmission layers, and each of the two or more first signal fields indicates a configuration of at least one of a spatial stream, a resource unit and a time unit carrying one of the two or more transmission layers, and wherein the transmitter transmits the signal to the single second communication apparatus based on the configuration.

14. The second communication apparatus of claim 13, wherein the signal further comprises a second signal field indicating the number of two or more first signal fields.

15. A communication method implemented by a first communication apparatus comprising:
generating a signal comprising two or more transmission layers, each of the two or more transmission layers carrying a data stream, wherein the data streams carried in the two or more transmission layers are configured with different sets of transmit parameters but directed to a single second communication apparatus; and
transmitting the signal to the single second communication apparatus.

16. A communication method implemented by a second communication apparatus comprising:
receiving a signal comprising two or more transmission layers from a first communication apparatus, each of the two or more transmission layers carrying a data stream, wherein the data streams carried in the two or more transmission layers are configured with different sets of transmit parameters but directed to the second communication apparatus; and
processing and decoding the signal.
